(19) United States
(12) Patent Application Publication
(10) Pub. No.: US 2017/0276938 A1
(43) Pub. Date: Sep. 28, 2017

(54) HEAD-UP DISPLAY DEVICE

(71) Applicant: MAZDA MOTOR CORPORATION, Hiroshima (JP)

(72) Inventors: Hidenobu NAKASHIMA, Hiroshima-shi (JP); Yo KITAMURA, Hiroshima-shi (JP); Hado MOROKAWA, Hiroshima-shi (JP); Seiji HISADA, Higashihiroshima-shi (JP); Taro OIKE, Kure-shi (JP); Kenji OKADA, Higashihiroshima-shi (JP)

(73) Assignee: MAZDA MOTOR CORPORATION, Hiroshima (JP)

(21) Appl. No.: 15/514,229

(22) PCT Filed: Mar. 15, 2016
(86) PCT No.: PCT/JP2016/058192

§ 371 Date: Mar. 24, 2017

(30) Foreign Application Priority Data
Mar. 25, 2015 (JP) 2015-062987

(51) Int. Cl. G02B 27/01; G08G 1/16; B60K 35/00; G01C 21/36

(52) U.S. Cl. CPC G02B 27/0101; G01C 21/365; G08G 1/166; B60K 35/00; G02B 27/01; B60R 1/00

(57) ABSTRACT

The present application discloses a head-up display device which is mounted on a vehicle. The head-up display device includes a projection device which emits image light onto a reflective surface including a first area, and a second area below the first area. The image light includes first image light representing first information including information about an external factor outside the vehicle, and second image light representing second information about the vehicle itself. The projection device emits the first image light onto the first area and the second image light onto the second area.

### TECHNICAL FIELD

The present invention relates to a head-up display device which is mounted on a vehicle.

### BACKGROUND ART

A head-up display device provides a variety of visual information to a driver of which line of sight is directed outside a vehicle (c.f. Patent Document 1). Therefore, the head-up display device contributes to safe driving for the vehicle.

Patent Document 1 proposes setting a priority to information which is given to the driver. According to Patent Document 1, a display area for information is determined according to the priority.

The priority proposed in Patent Document 1 is determined irrespective of a driving operation pattern of the driver. Therefore, if information is displayed by the techniques disclosed in Patent Document 1, the driver may not intuitively grasp necessary information.

### Patent Document

Patent Document 1: JP 2013-189122 A

### SUMMARY OF INVENTION

An object of the present invention is to provide a head-up display device which allows a driver to intuitively acquire necessary information.

A head-up display device according to one aspect of the present invention is mounted on a vehicle. The head-up display device includes a projection device which emits an image light onto a reflective surface including a first area and a second area below the first area. The image light includes a first image light representing first information about an external factor outside the vehicle, and a second image light representing second information about the vehicle itself. The projection device emits the first image light onto the first area and the second light onto the second area.

The head-up display device allows a driver to intuitively acquire necessary information.

These and other objects, features and advantages of the present invention will become more apparent upon reading the following detailed description along with the accompanying drawings.

### BRIEF DESCRIPTION OF DRAWINGS

FIG. 1 is a conceptual view showing a head-up display device according to the first embodiment;

FIG. 2 is a schematic layout of the head-up display device shown in FIG. 1 (the second embodiment);

FIG. 3A shows a schematic image represented by an image light which is emitted toward a windshield by the head-up display device depicted in FIG. 2 (the third embodiment);

FIG. 3B shows another schematic image represented by an image light which is emitted toward the windshield by the head-up display device depicted in FIG. 2 (the third embodiment);

FIG. 3C shows another schematic image represented by an image light which is emitted toward the windshield by the head-up display device depicted in FIG. 2 (the third embodiment);

FIG. 3D shows another schematic image represented by an image light which is emitted toward the windshield by the head-up display device depicted in FIG. 2 (the third embodiment);

FIG. 4A is a schematic view showing an exemplary boundary image which is displayed on the windshield under a first display mode by the head-up display device depicted in FIG. 2 (the fourth embodiment);

FIG. 4B is a schematic view showing the windshield under a second display mode (the fourth embodiment);

FIG. 5 shows a schematic image represented by an image light which is emitted toward the windshield by the head-up display device depicted in FIG. 2 (the fifth embodiment);

FIG. 6 shows another schematic image represented by an image light which is emitted toward the windshield by the head-up display device depicted in FIG. 2 (the fifth embodiment);

FIG. 7 is a schematic block diagram showing an exemplary functional configuration of the head-up display device depicted in FIG. 2 (the sixth embodiment);

FIG. 8 is a flowchart showing an exemplary process for switching a display mode (the seventh embodiment);

FIG. 9 shows a schematic image represented by an image light which is emitted toward the windshield by the head-up display device depicted in FIG. 2 (the eighth embodiment);

FIG. 10 is a schematic block diagram showing an exemplary functional configuration of the head-up display device depicted in FIG. 2 (the ninth embodiment);

FIG. 11A is a conceptual view showing a method for determining a positional relationship between a vehicle and a lane (the tenth embodiment);

FIG. 11B is a conceptual view showing the method for determining the positional relationship between the vehicle and the lane (the tenth embodiment);

FIG. 12A is a conceptual view showing exemplary image data stored in a second storage of the head-up display device depicted in FIG. 10 (the eleventh embodiment);

FIG. 12B is a conceptual view showing exemplary image data stored in the second storage of the head-up display device depicted in FIG. 10 (the eleventh embodiment);

FIG. 12C is a conceptual view showing exemplary image data stored in the second storage of the head-up display device depicted in FIG. 10 (the eleventh embodiment);

FIG. 13 is a flowchart showing an exemplary process for switching a display mode (the twelfth embodiment);

FIG. 14 is a schematic block diagram showing an exemplary functional configuration of the head-up display device depicted in FIG. 2 (the thirteenth embodiment);

FIG. 15 is a schematic view showing a boundary image (the fourteenth embodiment);

FIG. 16 is a schematic block diagram showing an exemplary functional configuration of the head-up display device depicted in FIG. 2 (the fifteenth embodiment); and

FIG. 17 is a conceptual view showing exemplary boundary data stored in a first storage of the head-up display device depicted in FIG. 16 (the sixteenth embodiment).

### DESCRIPTION OF EMBODIMENTS

### First Embodiment

The inventors found that a driver may intuitively acquire information if the information is displayed according to a driving operation pattern of the driver. In many cases, the driver directs his/her line of sight upwardly when the driver views a factor existing outside a vehicle (e.g. a signboard indicating a legal speed, a line formed on a road surface for use in indicating a lane or a preceding vehicle). On the other hand, a lot of information about the vehicle itself is displayed on an indicator panel. Therefore, the driver directs his/her line of sight downwardly in many cases in order to obtain information about the vehicle itself. A head-up display is described in the first embodiment, the head-up display being configured to display information according to such a driving operation pattern.

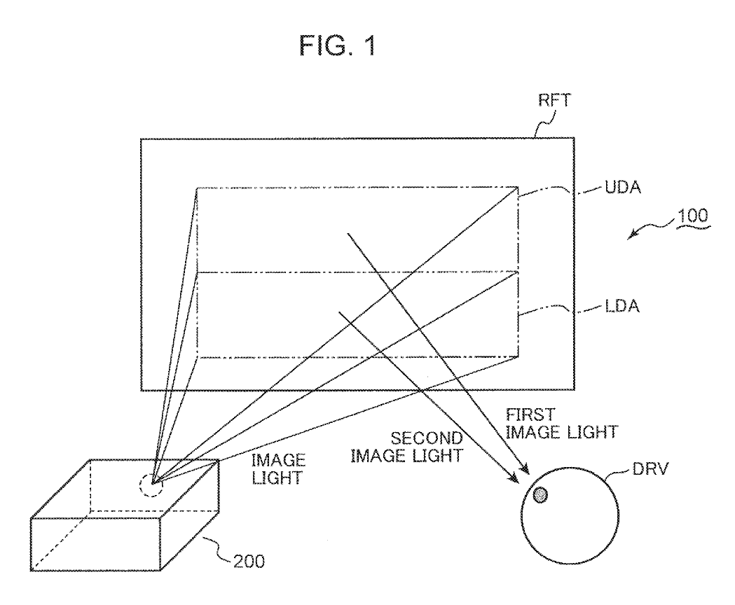

FIG. 1 is a conceptual view showing a head-up display device 100 according to the first embodiment. The head-up display device 100 is described with reference to FIG. 1.

The head-up display device 100 includes a projection device 200. The projection device 200 is mounted on a vehicle (not shown). The projection device 200 may be a general projector configured to emit an image light in response to an image signal. The principles of the present embodiment are not limited to a specific structure of the projection device 200.

FIG. 1 conceptually shows a reflective surface RFT. The reflective surface RFT may be a windshield of a vehicle. Alternatively, the reflective surface RFT may be a reflective element (e.g. a hologram element or a half-mirror) situated on an optical path of the image light emitted from the projection device 200. The principles of the present embodiment are not limited to a specific member which forms the reflective surface RFT.

The projection device 200 generates an image light in response to an image signal. The image light is emitted from the projection device 200 to the reflective surface RFT.

FIG. 1 conceptually shows an upper display area UDA and a lower display area LDA on the reflective surface RFT. The lower display area LDA is situated below the upper display area UDA. With regard to the present embodiment, the first area is exemplified by the upper display area UDA. The second area is exemplified by the lower display area LDA.

FIG. 1 conceptually shows a driver DRV. The image light includes a first image light and a second image light. The first image light is emitted from the projection device 200 toward the upper display area UDA. The second image light is emitted from the projection device 200 toward the lower display area LDA. The upper display area UDA reflects a part of the first image light toward the driver DRV. The lower display area LDA reflects a part of the second image light toward the driver DRV. Therefore, the driver DRV may visually grasp information represented by the first and second image lights.

The first image light may represent first information including information about an external factor outside the vehicle. For instance, the first information may include navigation information for navigating to a destination. The first information may include legal speed information about a legal speed determined for a lane along which the vehicle runs. The projection device 200 may generate an image signal from a signal which is output from a navigation system mounted on the vehicle, and then may generate an image light representing the navigation information and/or the legal speed information. The image generation techniques for displaying the navigation information and the legal speed information as an image may rely on various image processing techniques applied to existing vehicles. Therefore, the principles of the present embodiment are not limited to a specific image generation technique for displaying the navigation information and the legal speed information as an image.

The first information may include inter-vehicle distance information about a distance setting between the vehicle driven by the driver DRV and a preceding vehicle which is targeted in an auto cruise control. The projection device 200 may generate an image signal representing the inter-vehicle distance information in collaboration with a control program which is used for the auto cruise control. The image generation techniques for displaying the inter-vehicle distance information as an image may rely on existing auto cruise control techniques. Therefore, the principles of the present embodiment are not limited to a specific image generation technique for displaying the inter-vehicle distance information as an image.

The first information may include lane information indicating a positional relationship between the vehicle driven by the driver DRV and a lane along which the vehicle runs. The projection device 200 may use a signal from a camera device mounted on the vehicle to generate an image signal representing the lane information. The image generation techniques for displaying the lane information as an image may rely on various existing image processing techniques. Therefore, the principles of the present embodiment are not limited to a specific image generation technique for displaying the lane information as an image.

The second image light may represent second information about the vehicle itself which is driven by the driver DRV. For instance, the second information may include running speed information about an actual running speed of the vehicle driven by the driver DRV. The projection device 200 may generate an image light representing running speed information from a detection signal which is output from various sensors mounted on the vehicle. The image generation techniques for displaying the running speed information as an image may rely on various signal processing techniques applied to existing vehicles. Therefore, the principles of the present embodiment are not limited to a specific image generation technique for displaying the running speed information as an image.

The second image light may include setting speed information about a running speed setting of the vehicle in the auto cruise control. The projection device 200 may generate an image signal which represents the setting speed information in collaboration with a control program which is used for the auto cruise control. The image generation techniques for displaying the setting speed information as an image may rely on existing auto cruise control techniques. Therefore, the principles of the present embodiment are not limited to a specific image generation technique for displaying the setting speed information as an image.

The projection device 200 may emit an image light including a variety of information. If information exclusively represents information about the vehicle itself, the information being irrelevant to external factors outside the vehicle, the projection device 200 may output the information as the second image light. On the other hand, if information is associated with an external factor outside the vehicle, the information may be emitted as the first image light. Therefore, the principles of the present embodiment are not limited to specific information represented by an image light.

### Second Embodiment

A head-up display device may emit an image light toward a windshield of a vehicle. The windshield of the vehicle allows partial transmission of the image light, and reflects other parts of the image light. The reflected image light enters into the driver's eyes. Consequently, the driver may view a virtual image through the windshield. A head-up display device which emits image light toward a windshield is described in the second embodiment.

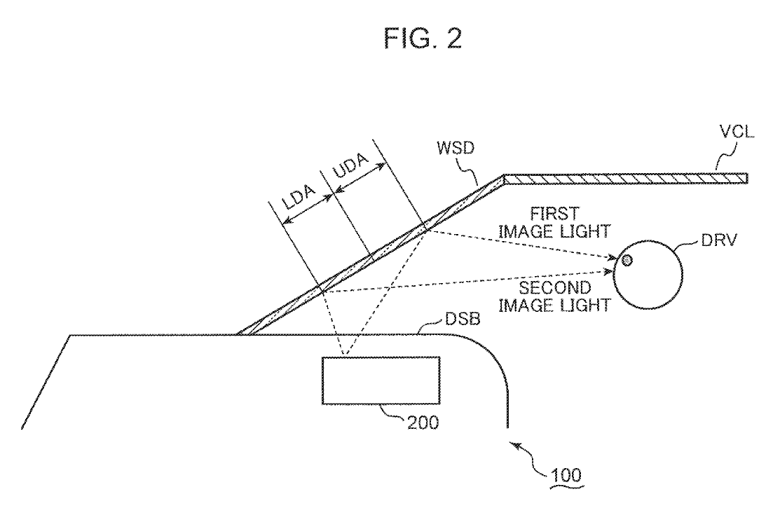

FIG. 2 is a schematic layout showing the head-up display device 100. Reference numerals used in common to the first and second embodiments indicate that elements indicated with the common reference numerals have the same functions as those of the elements in the first embodiment. Therefore, the description of the first embodiment is applied to these elements. The head-up display device 100 is described with reference to FIGS. 1 and 2.

FIG. 2 shows a vehicle VCL. The vehicle VCL includes a windshield WSD and a dashboard DSB. The windshield WSD is situated in front of the driver DRV. The dashboard DSB is situated below the windshield WSD.

The projection device 200 is stored in the dashboard DSB. The projection device 200 emits an image light toward the windshield WSD. As described in the context of the first embodiment, an area of the windshield WSD which receives an image light is conceptually divided into the upper and lower display areas UDA, LDA. Both of the first image light incident onto the upper display UDA and the second image light incident onto the lower display area LDA are reflected toward the driver DRY. Consequently, the driver DRV may visually recognize images represented by the first and second image lights as a virtual image through the windshield WSD.

Appropriate optical processing may be applied to the windshield WSD. Consequently, it is less likely that multiple images occur. Techniques for avoiding the multiple images may rely on various existing optical techniques. Therefore, the principles of the present embodiment are not limited to specific optical characteristics of the windshield WSD.

### Third Embodiment

A head-up display device may display various images on the basis of the principles described in the context of the first and second embodiments. An exemplary image to be displayed by a head-up display device is described in the third embodiment.

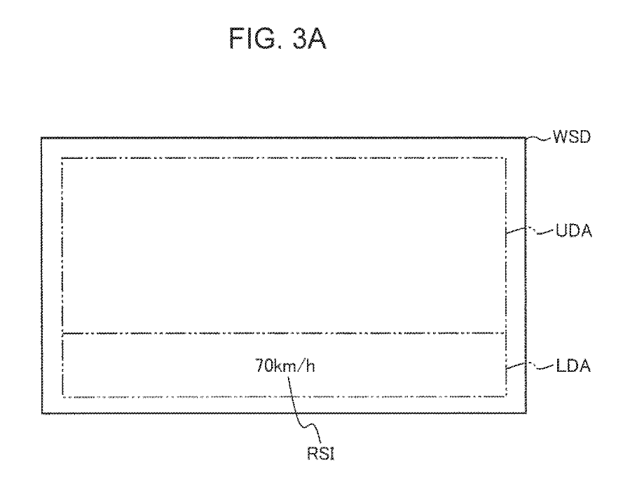

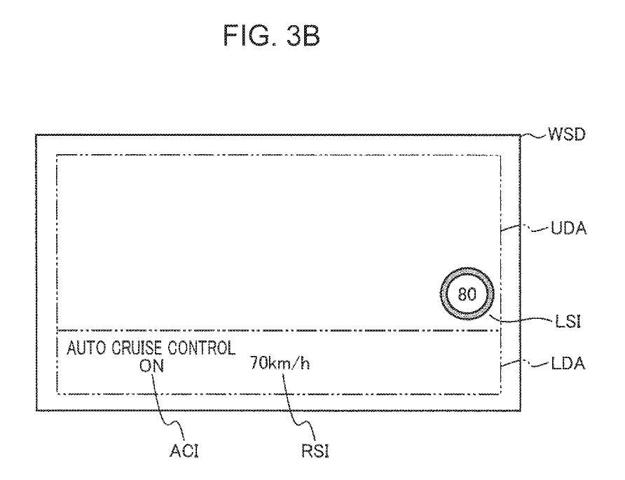

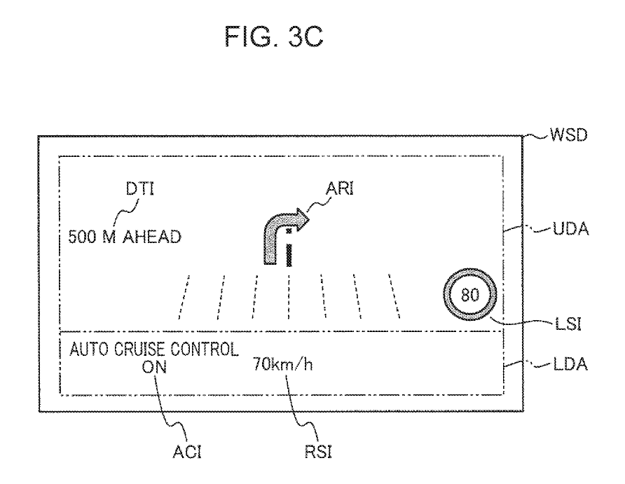

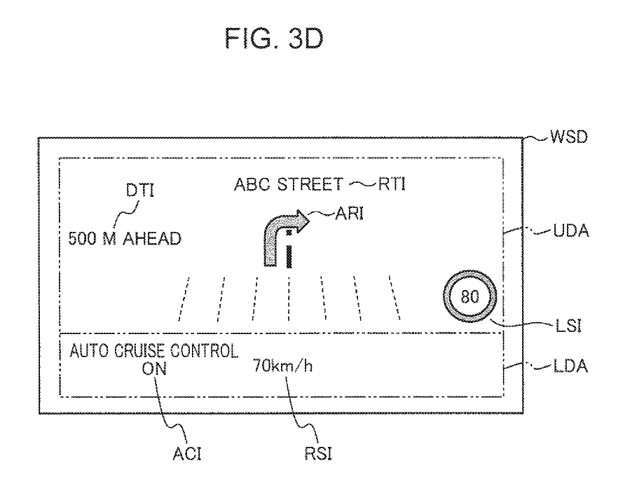

Each of FIGS. 3A to 3D shows a schematic image represented by an image light which is emitted from the head-up display device 100 (c.f. FIG. 2) toward the windshield WSD. Reference numerals used in common to the first to third embodiments indicate that elements indicated with the common reference numerals have the same functions as those of the elements in the first and/or second embodiments. Therefore, the description of the first and/or second embodiments is applied to these elements. An exemplary image to be displayed by the head-up display device 100 is described with reference to FIGS. 2 to 3D.

Each of FIGS. 3A to 3D schematically shows the windshield WSD. The upper and lower display areas UDA, LDA are defined in the windshield WSD,

As shown in FIG. 3A, when the vehicle VCL (c.f. FIG. 2) runs at a speed “70 km/h”, the projection device 200 (c.f. FIG. 2) emits an image light representing a running speed image RSI of “70 km/h” onto the lower display area LDA. The image light which is reflected on the lower display area LDA notifies the driver DRV (c.f. FIG. 2) that the vehicle VCL is running at the speed “70 km/h”.

As shown in FIG. 3B, the projection device 200 may emit an image light representing another image, in addition to the running speed image RSI. FIG. 3B shows a setting state image ACI in the lower display area LDA, the setting state image ACI representing a setting state of an auto cruise control. The image light which is reflected on the lower display area LDA notifies the driver DRV that the auto cruise control is “in an ON-state”.

Unlike FIG. 3A, FIG. 3B shows that the projection device 200 emits the image light not only onto the lower display area LDA but also the upper display area UDA. The projection device 200 displays a legal speed image LSI representing a legal speed determined for a road on which the vehicle VCL runs. The driver DRV may watch the running speed image RSI in the lower display area LDA and the legal speed image LSI in the upper display area UDA to confirm whether or not the vehicle VCL runs at an appropriate speed. A positional relationship between the running speed image RSI and the legal speed image LSI is similar to a positional relationship between an indicator panel (not shown) of the vehicle VCL and a signboard displaying a legal speed outside the vehicle VCL. The driver DRV may visually confirm information displayed by the bead-up display device 100 with a line of sight motion, which is similar to a line of sight motion when the driver DRV confirms whether or not the vehicle VCL runs at an appropriate running speed without the head-up display device 100.

When the driver DRV activates a navigation system (not shown) of the vehicle VCL as shown in FIG. 3C, the projection device 200 may display an image light on the upper display area UDA, the image light representing an image for guiding the driver DRV. FIG. 3C shows an arrow image ARI and a distance image DTI. The driver DRV may watch the arrow image ARI and the distance image DTI to recognize that the vehicle VCL should “turn right” after “500 m”.

As shown in FIG. 3D, the projection device 200 may emit an image light onto the upper display area, the image light representing a road information image RTI which indicates a name of a road, in addition to the arrow image ARI and the distance image DTI.

Switching an image between FIGS. 3A and 3D may rely on an operation of the driver DRV for the vehicle VCL. The running speed image RSI may be displayed from when the driver DRV turns on the ignition switch (not shown) of the vehicle VCL until the driver DRV turns off the ignition switch. The setting state image ACI may be displayed only when the driver DRV activates the auto cruise control of the vehicle VCL. Alternatively, the display contents of the setting state image ACI may be changed between when the driver DRV activates the auto cruise control and when the driver DRV deactivates the auto cruise control. The legal speed image LSI may be displayed only when the driver DRY requests the head-up display device 100 to display an image. Alternatively, the legal speed image LSI may be automatically displayed when the vehicle VCL runs at a speed exceeding a legal speed. The arrow image ARI, the distance image DTI and the road information image RTI may be displayed only when the driver DRV activates the navigation system of the vehicle VCL. The principles of the present embodiment are not limited to a specific image switching technique.

### Fourth Embodiment

As described in the context of the first to third embodiments, if information about an external factor outside a vehicle is included, the head-up display device emits an image light onto an upper area. On the other hand, the head-up display device emits an image light onto a lower area in order to display information about the vehicle itself. The head-up display device may emit a boundary light as an image light representing a boundary between the upper area and the lower area, in addition to an image light representing a variety of information. When the boundary light is emitted, a driver is likely to receive visual impression that arrangement of images is well-organized. On the other hand, when the boundary light is constantly emitted, the head-up display device may unnecessarily consume electric power. Therefore, the head-up device may switch a display mode between a first display mode, in which the boundary is displayed, and a second display mode, in which the boundary is not displayed. The first and second display modes are described in the fourth embodiment.

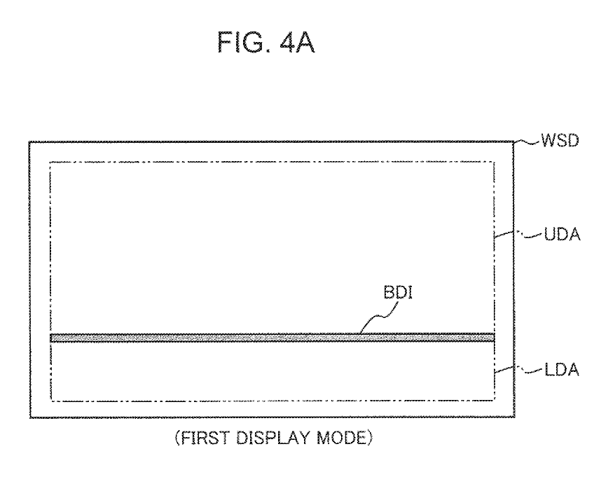

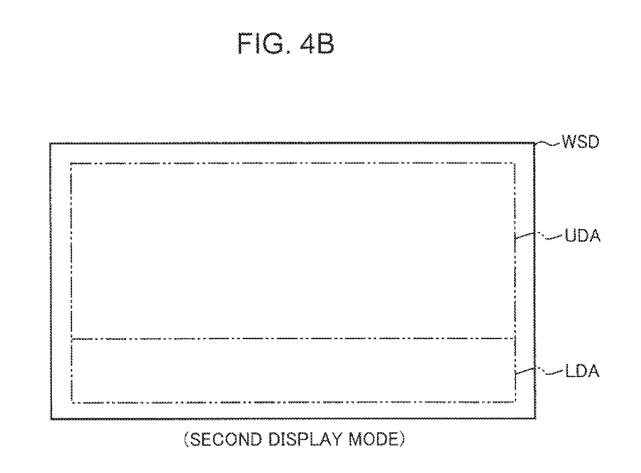

FIG. 4A is a schematic view showing an exemplary boundary image BDI which is displayed on the windshield WSD by the head-up display device 100 (c.f. FIG. 2) under the first display mode. FIG. 4B is a schematic view showing the windshield WSD under the second display mode. Reference numerals used in common to the first to fourth embodiments indicate that elements indicated with the common reference numerals have the same functions as those of the elements in at least one of the first to third embodiments. Therefore, the description of the first to third embodiments is applied to these elements. An exemplary image to be displayed by the head-up display device 100 is described with reference to FIGS. 2 to 4B.

Each of FIGS. 4A and 4B schematically shows the windshield WSD. The upper and lower display areas UDA, LDA are defined in the windshield WSD.

As shown in FIG. 4A, the head-up display device 100 emits a boundary light as an image light onto a boundary between the upper and lower display areas UDA, LDA. Consequently, the boundary image BDI is displayed on the boundary between the upper and lower display areas UDA, LDA.

The head-up display device 100 may emit at least one of the first and second image lights (c.f. FIG. 2) together with the boundary light under the first display mode. In this case, the first and/or second image lights may include a variety of information. The principles of the present embodiment are not limited to specific contents of information represented by the first and/or second image lights which are emitted together with the boundary light.

Unlike the first display mode, the head-up display device 100 does not emit the boundary light (c.f. FIG. 4B) under the second display mode. The various images (c.f. FIGS. 3A to 3D) described in the context of the third embodiment do not include the boundary image BDI. Therefore, these images may be displayed by the head-up display device 100 under the second display mode.

The head-up display device 100 may switch a display mode between the first and second display modes in response to a manual operation of the driver DRV (c.f. FIG. 2). Alternatively, the head-up display device 100 may automatically switch a display mode according to a running state of the vehicle VCL (c.f. FIG. 2). The principles of the present embodiment are not limited to a specific technique for switching a display mode between the first and second display modes.

### Fifth Embodiment

A head-up display device may display a boundary image under the first display mode according to the principles described in the context of the fourth embodiment. A positional relationship between a boundary image and an area above the boundary image is similar to a positional relationship between a hood and scenery viewed through a windshield. The head-up display device may use the aforementioned positional similarity to display an image which is used for a distance setting between a vehicle driven by a driver and a preceding vehicle to be targeted in an auto cruise control. An exemplary image for use in setting an auto cruise control is described in the fifth embodiment.

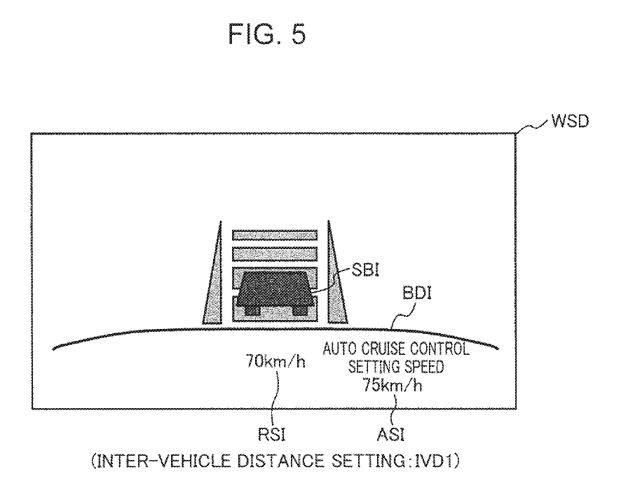

FIG. 5 shows a schematic image which is displayed by an image light which is emitted from the head-up display device 100 toward the windshield WSD. Reference numerals used in common to the fourth and fifth embodiments indicate that elements indicated with the common reference numerals have the same functions as those of the elements in the fourth embodiment. Therefore, the description of the fourth embodiment is applied to these elements. An exemplary image for use in setting an auto cruise control is described with reference to FIGS. 2 and 5.

FIG. 5 schematically shows the windshield WSD. Like the fourth embodiment, the projection device 200 (c.f. FIG. 2) emits a boundary light representing the boundary image BDI. An area above the boundary image BDI corresponds to the upper display area UDA described with reference to FIG. 2. An area below the boundary image BDI corresponds to the lower display area LDA described with reference to FIG. 2,

As shown in FIG. 5, the boundary image BDI may form an arc curved upwardly, like a surface contour of a hood of the vehicle VCL (c.f. FIG. 2). Alternatively, the head-up display device 100 may give another shape to the boundary image BDI. The principles of the present embodiment are not limited to a specific shape of the boundary image BDI.

As described with reference to FIG. 2, the projection device 200 emits the first image light onto the upper display area UDA. As shown in FIG. 5, the first image light may represent a symbol image SBI, which conceptually indicates a preceding vehicle to be targeted in an auto cruise control. A distance between the symbol image SBI and the boundary image BDI may be a setting distance between the vehicle VCL and the targeted preceding vehicle. With regard to the present embodiment, the inter-vehicle distance information is exemplified by the symbol image SBI and the boundary image BDI.

As described with reference to FIG. 2, the projection device 200 emits the second image light onto the lower display area LDA. As shown in FIG. 5, the second image light may represent the running speed image RSI. The second image light may represent the setting speed image ASI indicating a setting speed in the auto cruise control, in addition to the running speed image RSI. FIG. 5 shows that the setting speed is set to “75 km/h”. The vehicle VCL runs at about 75 km/h without the targeted preceding vehicle. Or, the vehicle VCL stops following the preceding vehicle and runs at about 75 km/h if a vehicle recognized as the targeted vehicle starts to run at a speed exceeding 75 km/h. The second image light may be used for displaying various other images. The principles of the present embodiment are not limited to specific contents represented by the second image light.

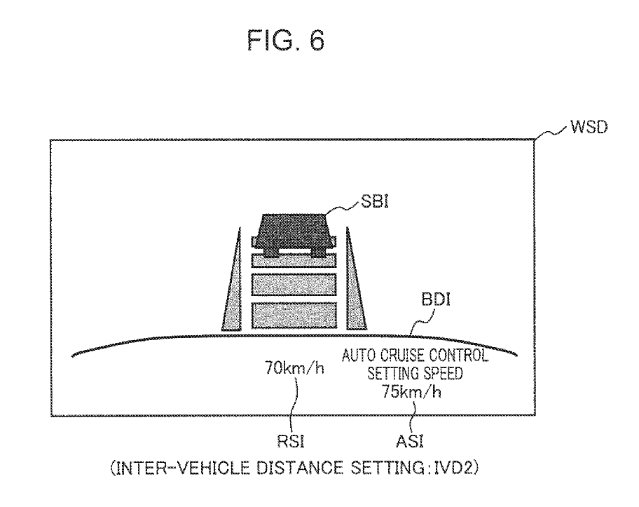

FIG. 6 shows another schematic image represented by an image light which is emitted from the head-up display device 100 to the windshield WSD. An exemplary image for use in setting the auto cruise control is described with reference to FIGS. 2, 5 and 6.

Like FIG. 5, FIG. 6 shows the boundary image BDI, the symbol image SBI, the running speed image RSI and the setting speed image ASI. The symbol image SBI shown in FIG. 6 is different in relative position relationship with the boundary image BDI from the symbol image SBI shown in FIG. 5. FIG. 5 shows that an inter-vehicle distance between the vehicle VCL and the preceding vehicle to be targeted in the auto cruise control is set to a value “IVD1”. FIG. 6 shows that the inter-vehicle distance between the vehicle VCL and the preceding vehicle is set to a value “IVD2”. The value “IVD2” is larger than the value “IVD1”. A distance between the symbol image SBI and the boundary image BDI shown in FIG. 6 is longer than a distance between the symbol image SBI and the boundary image BDI shown in FIG. 5. With regard to the present embodiment, the first value is exemplified by the value “IVD1”. The second value is exemplified by the value “IVD2”. The first length is exemplified by the distance from the boundary image BDI to the symbol image SBI shown in FIG. 5. The second length is exemplified by the distance from the boundary image BDI to the symbol image SBI shown in FIG. 6.

### Sixth Embodiment

A head-up display device may provide a driver with an image for use in setting an auto cruise control according to the principles described in the context of the fifth embodiment. A designer designing the head-up display device may use various image generation techniques (e.g. programming techniques or circuit designing techniques) for displaying an image described in the context of the fifth embodiment. Exemplary techniques for displaying an image for use in setting an auto cruise control are described in the sixth embodiment.

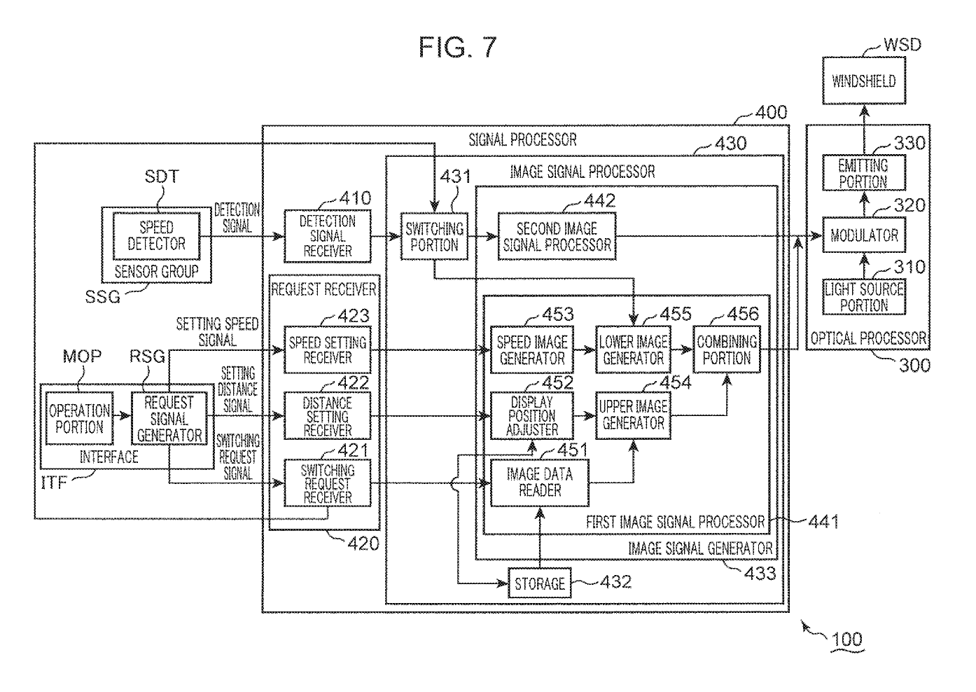

FIG. 7 is a schematic block diagram showing an exemplary functional configuration of the head-up display device 100 (c.f. FIG. 2). Reference numerals used in common to the fifth and sixth embodiments indicate that elements indicated with the common reference numerals have the same functions as those of the elements in the fifth embodiment. Therefore, the description of the fifth embodiment is applied to these elements. The head-up display device 100 is described with reference to FIGS. 2 to 3D and 5 to 7.

The head-up display device 100 includes an optical processor 300 and a signal processor 400. The optical processor 300 corresponds to the projection device 200 described with reference to FIG. 2. The signal processor 400 may be a part of the projection device 200. Alternatively, the signal processor 400 may be a circuit provided independently of the projection device 200. In this case, the signal processor 400 may be a part of a circuit for processing various signals in the vehicle VCL (c.f. FIG. 2). The principles of the present embodiment are not limited to a specific structure of the signal processor 400.

As described in the context of the second embodiment, the vehicle VCL includes the windshield WSD. The optical processor 300 emits an image light (the first and/or second image lights, c.f. FIG. 2) toward the windshield WSD.

The vehicle VCL includes a sensor group SSG and an interface ITF, in addition to the windshield WSD. The sensor group SSG may include various sensor elements for detecting a running state of the vehicle VCL and various devices (e.g. a camera device or a communication device) for acquiring information outside the vehicle VCL. The interface ITF receives a manual operation of the driver DRV (c.f. FIG. 2).

The sensor group SSG includes a speed detector SDT. The speed detector SDT may include various sensor elements for detecting a running speed of the vehicle VCL. The speed detector SDT generates a detection signal representing a running speed of the vehicle VCL. The detection signal is output from the speed detector SDT to the signal processor 400. The detection techniques for detecting a speed of the vehicle VCL may rely on techniques for use in various existing vehicles. The principles of the present embodiment are not limited to a specific technique for detecting a running speed of the vehicle VCL.

The interface ITF includes an operation portion MOP and a request signal generator RSG. The driver DRY may operate the operation portion MOP to request displaying the image (c.f. FIGS. 5 and 6) described in the context of the fifth embodiment. The request signal generator RSG generates a request signal in response to the operation of the driver DRV. The request signal is output from the request signal generator RSG to the signal processor 400.

The request signal includes a switching request signal, a setting distance signal and a setting speed signal. The switching request signal transmits a display switching request for the image, which is described in the context of the fifth embodiment, to the signal processor 400. The setting distance signal transmits a distance setting between the vehicle VCL and a preceding vehicle in an auto cruise control to the signal processor 400. The setting speed signal transmits a running speed setting of the vehicle VCL in the auto cruise control to the signal processor 400.

The operation portion MOP may be a steering switch near a steering wheel. The steering switch may be a lever, a button, a dial or another structure configured to receive a manual operation of the driver DRV. The principles of the present embodiment are not limited to a specific structure of the operation portion MOP.

The request signal generator RSG may be a computer which executes a program for the auto cruise control. Designing the request signal generator RSG may rely on a variety of existing auto cruise control techniques. The principles of the present embodiment are not limited to a specific program or a specific computer device for use in the request signal generator RSG.

The signal processor 400 includes a detection signal receiver 410, a request receiver 420 and an image signal processor 430. The detection signal receiver 410 receives the detection signal from the speed detector SDT. The detection signal is then output from the detection signal receiver 410 to the image signal processor 430. The image signal processor 430 may display various images (e.g. the images described with reference to FIGS. 3A to 3D) in response to the detection signal.

The request receiver 420 includes a switching request receiver 421, a distance setting receiver 422 and a speed setting receiver 423. The request receiver 420 receives the request signal (i.e. the switching request signal, the setting distance signal and the setting speed signal) from the request signal generator RSG. The request signal is then output from the request receiver 420 to the image signal processor 430.

The switching request receiver 421 receives the switching request signal from the request signal generator RSG. The switching request signal is then output from the switching request receiver 421 to the image signal processor 430. The image signal processor 430 processes signals in response to the switching request signal in order to display the image (i.e. the image for use in setting the auto cruise control) which is described with reference to FIGS. 5 and 6.

The distance setting receiver 422 receives the setting distance signal from the request signal generator RSG. The setting distance signal is then output from the distance setting receiver 422 to the image signal processor 430. The image signal processor 430 determines a distance between the boundary image BDI (c.f. FIGS. 5 and 6) and the symbol image SRI (c.f. FIGS. 5 and 6) in response to the distance setting signal.

The speed setting receiver 423 receives the setting speed signal from the request signal generator RSG. The setting speed signal is then output from the speed setting receiver 423 to the image signal processor 430. The image signal processor 430 determines contents of the setting speed image ASI (c.f. FIGS. 5 and 6) in response to the setting speed signal.

The image signal processor 430 includes a switching portion 431, a storage 432 and an image signal generator 433. The switching portion 431 receives the detection signal from the detection signal receiver 410. The switching portion 431 receives the switching request signal from the switching request receiver 421. The switching portion 431 switches an output destination of the detection signal in response to the switching request signal. The storage 432 stores various data required for image generation. The image signal generator 433 may read data from the storage 432 to generate various images in response to the detection signal and/or the request signal.

The image signal generator 433 includes a first image signal processor 441 and a second image signal processor 442. The switching portion 431 sets one of the first and second image signal processors 441, 442 as the output destination of the detection signal in response to the switching request signal. When the switching portion 431 outputs the detection signal to the first image signal processor 441, the first image signal processor 441 generates an image signal for displaying the image described with reference to FIGS. 5 and 6 in response to the detection signal and the request signal. When the switching portion 431 outputs the detection signal to the second image signal processor 442, the second image signal processor 442 generates an image signal for displaying another image (e.g. the image described with reference to FIGS. 3A to 3D) in response to the detection signal. The optical processor 300 receives the image signal from one of the first and second image signal processors 441, 442.

The first image signal processor 441 includes an image data reader 451, a display position adjuster 452, a speed image generator 453, an upper image generator 454, a lower image generator 455 and a combining portion 456.

The image data reader 451 receives the switching request signal from the switching request receiver 421. The image data reader 451 reads the image data from the storage 432 in response to receiving the switching request signal. The image data which is read from the storage 432 may include information about the boundary image BDI and information about a shape of the symbol image SBI. The image data is then output from the image data reader 451 to the upper image generator 454.

The display position adjuster 452 receives the setting distance signal from the distance setting receiver 422. The display position adjuster 452 reads information about a display position of the symbol image SBI from the storage 432 in response to receiving the setting distance signal. The information about the display position of the symbol image SBI may represent an initial setting value about the position of the symbol image SBI relative to the boundary image BDI. Alternatively, information about the position of the symbol image SBI relative to the boundary image BDI may represent a value which is set immediately before. The display position adjuster 452 refers to the setting distance signal and data about the display position read from the storage 432 to determine a display position of the symbol image SBI. The position data about the determined display position is output from the display position adjuster 452 to the upper image generator 454 and the storage 432. As a result of the output of the position data to the storage 432, the position data is updated in the storage 432.

As described above, the image data for use in forming the boundary image BDI and the symbol image SBI is output from the image data reader 451 to the upper image generator 454. The upper image generator 454 generates an image signal to form the boundary image BDI and the symbol image SBI, which are formed in an area above the boundary image BDI. The upper image generator 454 generates an image signal so that the symbol image SBI is formed at a position which is determined by the position data output from the display position adjuster 452.

The speed image generator 453 receives the setting speed signal from the speed setting receiver 423. The speed image generator 453 generates image data for use in displaying the setting speed image ASI in response to the setting speed signal. The image data for use in displaying the setting speed image ASI is output from the speed image generator 453 to the lower image generator 455.

The lower image generator 455 receives the detection signal from the switching portion 431, in addition to the image data from the speed image generator 453. The lower image generator 455 generates image data for use in displaying the running speed image RSI in response to the detection signal. The lower image generator 455 uses the image data for displaying the setting speed image ASI and the running speed image RSI to generate an image signal for use in displaying an image in an area below the boundary image BD.

The image signal representing the boundary image BDI and the symbol image SBI above the boundary image BDI is output from the upper image generator 454 to the combining portion 456. The image signal for use in displaying the running speed image RSI and the setting speed image ASI below the boundary image BDI is output from the lower image generator 455 to the combining portion 456. The combining portion 456 may combine these image signals to generate an image signal for use in displaying the image described with reference to FIGS. 5 and 6. The image signal is output from the combining portion 456 to the optical processor 300.

When the detection signal is output from the switching portion 431 to the second image signal processor 442, the second image signal processor 442 refers to the detection signal to generate the image signal for use in displaying the running speed image RSI in the lower display area LDA (c.f. FIG. 2). The image signal is output from the second image signal processor 442 to the optical processor 300.

The optical processor 300 includes a light source portion 310, a modulator 320 and an emitting portion 330. The light source portion 310 generates laser light or other light suitable for generating an image light. The modulator 320 receives the image signal from one of the combining portion 456 and the second image signal processor 442. The modulator 320 modulates light emitted from the light source portion 310 in response to the image signal to generate an image light. The image light is emitted from the emitting portion 330 to the windshield WSD.

The light source portion 310 may be a general laser source. The light source portion 310 may include laser sources configured to emit laser lights which are different in wavelengths from each other. In this case, the head-up display device 100 may form an image on the windshield WSD with different hues. The principles of the present embodiment are not limited to a specific type of a light source which is used as the light source portion 310.

The modulator 320 may be a general spatial light modulator element. For instance, the modulator 320 may drive liquid crystal elements in response to an image signal from one of the combining portion 456 and the second image signal processor 442 to generate an image light. Alternatively, the modulator 320 may include an MEMS mirror which is driven by an image signal. Further alternatively, the modulator 320 may include a Galvano mirror or another reflective element which is driven by an image signal. The principles of the present embodiment are not limited to a specific structure of the modulator 320.

The emitting portion 330 may include various optical elements for image formation on the windshield WSD. For instance, the emitting portion 330 may include a projection lens or a screen. A designer designing the head-up display device 100 may use a structure for use in existing projectors in designing the emitting portion 330. The principles of the present embodiment are not limited to a specific structure of the emitting portion 330.

### Seventh Embodiment

The head-up display device described in the context of the sixth embodiment may execute various processes to switch a display mode between the first and second display modes. Exemplary processes for switching a display mode are described in the seventh embodiment.

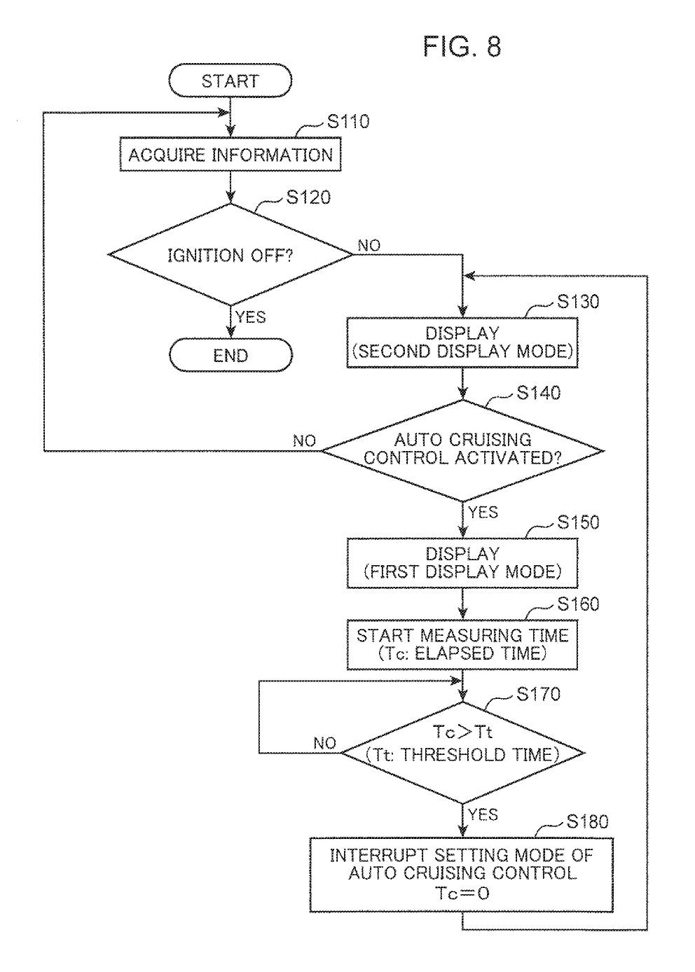

FIG. 8 is a flowchart showing exemplary processes for switching a display mode. Reference numerals used in common to the sixth and seventh embodiments indicate that elements indicated with the common reference numerals have the same functions as those of the elements in the sixth embodiment. Therefore, the description of the sixth embodiment is applied to these elements. Exemplary processes for switching a display mode is described with reference to FIGS. 2 to 4B, 7 and 8.

### (Step S110)

Step S110 is started, for instance, when the driver DRV (c.f. FIG. 2) turns on the ignition switch (not shown). In Step S110, the speed detector SDT (c.f. FIG. 7) in the sensor group SSG (c.f. FIG. 7) detects a running speed of the vehicle VCL (c.f. FIG. 2). The speed detector SDT generates the detection signal representing the detected running speed. The detection signal is output from the speed detector SDT to the switching portion 431 via the detection signal receiver 410. The sensor group SSG may acquire other information. For instance, the sensor group SSG may acquire information about a legal speed or a route to a destination from a navigation system (not shown) mounted on the vehicle VCL. The information from the navigation system may be used for generating the legal speed image LSI (c.f. FIG. 3D), the distance image DTI (c.f. FIG. 3D), the arrow image ARI (c.f. FIG. 3D) or the road information image RTI (c.f. FIG. 3D). After the sensor group SSG acquires information necessary for image generation, Step S120 is executed.

### (Step S120)

When the driver DRV turns off the ignition switch (not shown), the head-up display device 100 (c.f. FIG. 7) finishes the process. Otherwise, Step S130 is executed.

### (Step S130)

The switching portion 431 (c.f. FIG. 7) receives the detection signal from the speed detector SDT via the detection signal receiver 410 (c.f. FIG. 7). The switching portion 431 then outputs the detection signal to the second image signal processor 442 (c.f. FIG. 7). The second image signal processor 442 uses the detection signal to generate an image signal representing various images. The detection signal is then output from the second image signal processor 442 to the optical processor 300 (c.f. FIG. 7). The optical processor 300 generates an image light in response to the image signal. The image light is then emitted from the optical processor 300 onto the windshield WSD (c.f. FIG. 7). Consequently, an image (e.g. the images described with reference to FIGS. 3A to 3D) is displayed on the windshield WSD. The windshield WSD reflects the image light. Consequently, the driver DRV may visually recognize a virtual image in correspondence to the image represented by the image light. The display operation of the head-up display device 100 in Step S130 corresponds to the second display mode described with reference to FIG. 4B. When the head-up display device 100 displays the image on the windshield WSD under the second display mode, Step S140 is executed.

### (Step S140)

When the driver DRV operates the operation portion MOP (c.f. FIG. 7) to activate the auto cruise control, Step S150 is executed. Otherwise, Step S110 is executed.

### (Step S150)

The request signal generator RSG (c.f. FIG. 7) generates a request signal (i.e. the switching request signal, the setting distance signal and the setting speed signal). The first image signal processor 441 (c.f. FIG. 7) processes the request signal in response to the signal processing principles described in the context of the sixth embodiment to generate an image signal representing the image described with reference to FIGS. 5 and 6. The image signal is then output from the first image signal processor 441 to the optical processor 300. The optical processor 300 generates an image light in response to the image signal. The image light is then emitted from the optical processor 300 onto the windshield WSD. Consequently, the image (the image described with reference to FIGS. 5 and 6) is displayed on the windshield WSD. The image light is reflected on the windshield WSD. Consequently, the driver DRV may visually recognize a virtual image in correspondence to the image represented by the image light. The display operation of the head-up display device 100 in Step S150 corresponds to the first display mode described with reference to FIG. 4A. When the head-up display device 100 displays the image on the windshield WSD under the first display mode, Step S160 is executed.

### (Step S160)

The switching portion 431 starts measuring a time. FIG. 8 shows an elapsed time as the symbol “Tc” from when Step S160 is executed. Step S170 is then executed.

### (Step 3170)

The switching portion 431 determines whether or not the elapsed time “Tc” exceeds a predetermined threshold time “Tt”. When the elapsed time “Tc” does not exceed the threshold time “t”, Step S170 is repeated. The threshold time “Tt” is set to a time period long enough (e.g. five seconds) for the driver DRV to complete setting the auto cruising control. While Step S170 is executed, the driver DRV may operate the operation portion MOP to set an inter-vehicle distance between the vehicle VCL and a preceding vehicle to be targeted in the auto cruising control, and a setting speed in the auto cruising control. The first image signal processor 441 generates an image signal so that a position of the symbol image SBI (c.f. FIGS. 5 and 6) relative to the boundary image BDI (c.f. FIGS. 5 and 6) is changed by the operation of the driver DRV. In addition, the first image signal processor 441 generates the image signal so that a number (a value of a setting speed) represented by the setting speed image ASI (c.f. FIGS. 5 and 6) is changed by the operation of the driver DRV. When the switching portion 431 determines that the elapsed time “Tc” exceeds the threshold time “Tc”, Step S180 is executed.

### (Step S180)

The switching portion 431 switches an output destination of the detection signal from the first image signal processor 441 to the second image signal processor 442. Consequently, the setting mode of the auto cruising control is interrupted or finished. In addition, the switching portion 431 resets a value of the elapsed time “Tc” to “0”. Step 3130 is then executed.

### Eighth Embodiment

A head-up display device may display an image for use in setting an auto cruise control under the first display mode according to the principles described in the context of the fifth to seventh embodiments. Alternatively, the head-up display device may display other information under the first display mode. For instance, the head-up display device may display lane information under the first display mode, the lane information indicating a positional relationship between a vehicle and a lane along which the vehicle runs. Exemplary lane information indicating a positional relationship between a vehicle and a lane along which the vehicle runs is described in the eighth embodiment.

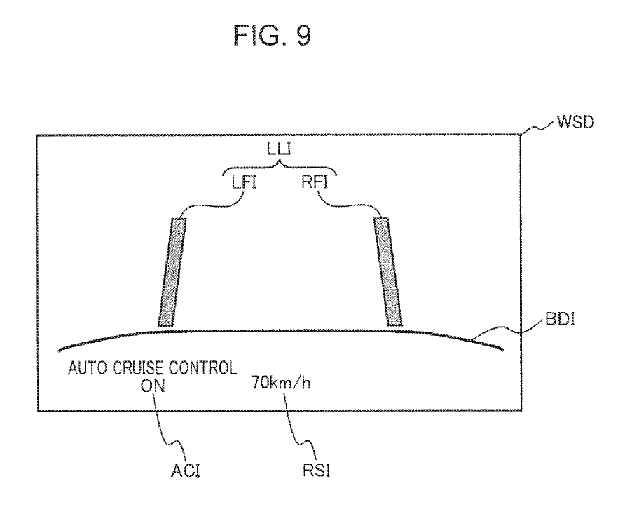

FIG. 9 shows a schematic image represented by an image light which is emitted from the head-up display device 100 (c.f. FIG. 2) toward the windshield WSD. Reference numerals used in common to the third, fifth and eighth embodiments indicate that elements indicated with the common reference numerals have the same functions as those of the elements in the third and/or fifth embodiments. Therefore, the description of the third and/or fifth embodiments is applied to these elements. Exemplary lane information indicating whether or not a vehicle deviates from a lane is described with reference to FIGS. 2 and 9.

FIG. 9 schematically shows the windshield WSD. Like the fifth embodiment, the projection device 200 (c.f. FIG. 2) emits the boundary light representing the boundary image BDI under the first display mode. An area above the boundary image BDI corresponds to the upper display area UDA described with reference to FIG. 2. An area below the boundary image BDI corresponds to the lower display area LDA described with reference to FIG. 2.

As described with reference to FIG. 2, the projection device 200 emits the first image light onto the upper display area UDA. The first image light represents a lane image LLI. The lane image LLI includes a left lane image LFT and a right lane image RFI. The left lane image LEI extends upwardly from a position near the boundary image BDI. The right lane image RFI extends upwardly from a position near the boundary image BDI on the right of the left lane image LFI. A positional relationship among the left and right lane images LFI, RFI and the boundary image BDI is similar to a positional relationship between a line mark formed on a road surface for use in displaying a lane in a field of view of the driver DRV (c.f. FIG. 2) and a hood of the vehicle VCL. Therefore, the driver DRV may intuitively recognize that the left and right lane images LFI, RFI correspond to a line mark formed on a road surface.

A camera device (not shown) for acquiring image data about an image on a road surface is mounted on the vehicle VCL (c.f. FIG. 2). The head-up display device 100 (c.f. FIG. 2) may detect a position of the vehicle VCL relative to a lane on the basis of the image data from the camera device. Determination about the position of the vehicle VCL relative to the lane may rely on existing determination techniques applied to various vehicles. Therefore, the principles of the present embodiment are not limited to a specific technique for determining a position of the vehicle VCL with respect to a lane.

When the vehicle VCL is about to deviate from a lane and/or deviates from the lane, the head-up display device 100 may display the lane image LLI. When the vehicle VCL is about to run over a right line mark formed on a road surface, the head-up display device 100 may blink the right lane image RFI. Meanwhile, the head-up display device 100 may display the left lane image LFI at fixed luminance. The driver DRV may then recognize that the vehicle VCL deviates from the right lane on the basis of the difference in display pattern between the right and left lane images RFI, LFI. The difference in display pattern between the right and left lane images RFI, LFI may be a hue difference between the right and left lane images RFI, LFI. The principles of the present embodiment are not limited to a specific indication for notifying the driver DRV of a deviation direction of the vehicle VCL. With regard to the present embodiment, the lane information is exemplified by the lane image LLI.

As described with reference to FIG. 2, the projection device 200 emits the second image light onto the lower display area LDA. As shown in FIG. 9, the second image light represents both of the setting state image ACI and the running speed image RSI. The setting state image ACI and the running speed image RSI are displayed below the boundary image BDI.

### Ninth Embodiment

A head-up display device may provide a driver with an image as the lane information according to the principles described in the context of the eighth embodiment, the image representing a positional relationship between a vehicle and a lane along which the vehicle runs. A designer designing the head-up display device may use various image generation techniques (e.g. a programming technique or a circuit designing technique) for displaying the image described in the context of the eighth embodiment. Techniques for displaying an image for use in providing the lane information are described in the ninth embodiment.

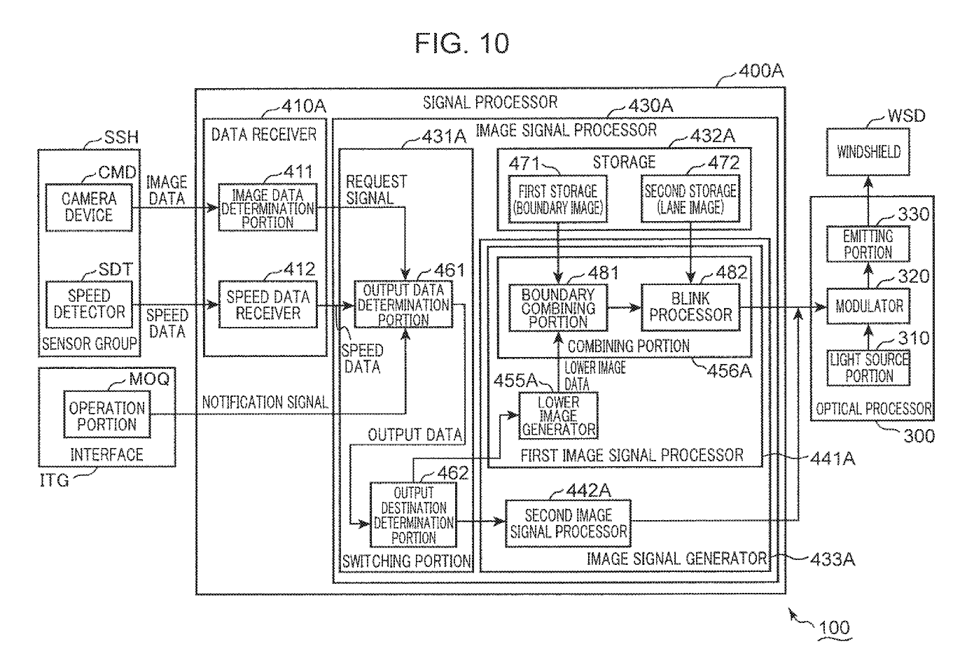

FIG. 10 is a schematic block diagram showing an exemplary functional configuration of the head-up display device 100. Reference numerals used in common to the sixth, eighth and ninth embodiments indicate that elements indicated with the common reference numerals have the same functions as those of the elements in the sixth and/or eighth embodiments. Therefore, the description of the sixth and/or eighth embodiments is applied to these elements. The head-up display device 100 is described with reference to FIGS. 2 to 3D, 9 and 10.

Like the sixth embodiment, the head-up display device 100 includes the optical processor 300. The description of the sixth embodiment is applied to the optical processor 300.

The head-up display device 100 further includes a signal processor 400A. The signal processor 400A may be a part of the projection device 200 (c.f. FIG. 2). Alternatively, the signal processor 400A may be a circuit provided independently of the projection device 200. In this case, the signal processor 400A may be a part of a circuit for processing various signals in the vehicle VCL (c.f. FIG. 2). The principles of the present embodiment are not limited to a specific structure of the signal processor 400A.

As described in the context of the second embodiment, the vehicle VCL includes the windshield WSD. The optical processor 300 emits an image light (the first and/or second image lights: c.f. FIG. 2) toward the windshield WSD.

The vehicle VCL includes a sensor group SSH and an interface ITG, in addition to the windshield WSD. The sensor group SSH may include various sensor elements for detecting a running state of the vehicle VCL, and various devices (e.g. a communication device) for acquiring information outside the vehicle VCL. The interface ITG receives a manual operation of the driver DRV (c.f. FIG. 2).

Like the sixth embodiment, the sensor group SSH includes the speed detector SDT. The description of the sixth embodiment is applied to the speed detector SDT. The speed detector SDT generates speed data representing a running speed of the vehicle VCL. The speed data corresponds to the detection signal described in the context of the sixth embodiment. Therefore, the description about the detection signal in the sixth embodiment may be applied to the speed data. The speed data is output from the speed detector SDT to the signal processor 400A.

The sensor group SSH further includes a camera device CMD. The camera device CMD captures an image of a road surface to generate image data representing the road surface. The image data is output from the camera device CMD to the signal processor 400A. The camera device CMD may be a CCD) camera, a CMOS camera or any other device configured to generate image data representing a road surface. The principles of the present embodiment are not limited to a specific device for use as the camera device CMD.

The interface ITG includes an operation portion MOQ. The driver DRV operates the operation portion MOQ to generate a notification signal which notifies that the auto cruising control is activated. The notification signal is output from the operation portion MOQ to the signal processor 400A. The signal processor 400A processes signals for displaying the setting state image ACI described with reference to FIG. 9 in response to the notification signal.

The operation portion MOQ may be a steering switch near a steering wheel. The steering switch may be a lever, a button, a dial or another structure configured to receive a manual operation of the driver DRV. The principles of the present embodiment are not limited to a specific structure of the operation portion MOQ.

The signal processor 400A includes a data receiver 410A and an image signal processor 430A.

The data receiver 410A includes an image data determination portion 411 and a speed data receiver 412. The image data is output from the camera device CMD to the image data determination portion 411. The image data determination portion 411 determines from the image data whether or not the vehicle VCL is running on an appropriate position in a lane. The determination techniques for determining whether or not the vehicle VCL is running on the appropriate position in the lane may rely on existing image recognition techniques. The principles of the present embodiment are not limited to a specific technique for determining whether or not the vehicle VCL is running on the appropriate position in the lane.

When a positional relationship between the vehicle VCL and a line mark formed on a road surface (a mark indicating an edge of the lane) is inappropriate, the image data determination portion 411 generates a request signal which requests display of the lane image LLI described with reference to FIG. 9. The request signal is output from the image data determination portion 411 to the image signal processor 430A.

The speed data receiver 412 receives the speed data from the speed detector SDT. The speed data is then output from the speed data receiver 412 to the image signal processor 430A.

The image signal processor 430A includes a switching portion 431A, a storage 432A and an image signal generator 433A.

The switching portion 431A includes an output data determination portion 461 and an output destination determination portion 462. The output data determination portion 461 receives the speed data from the speed data receiver 412. When the image data determination portion 411 generates the request signal, the request signal is output from the image data determination portion 411 to the output data determination portion 461. When the driver DRV operates the operation portion MOQ to activate the auto cruising control, the notification signal is output from the operation portion MOQ to the output data determination portion 461.

When the output data determination portion 461 receives only the speed data, the output data determination portion 461 generates the speed data as output data. When the output data determination portion 461 receives the notification signal in addition to the speed data, the output data determination portion 461 generates output data, in which the display request for the setting state image ACI is added to the speed data. When the output data determination portion 461 receives the request signal in addition to the speed data, the output data determination portion 461 generates output data, in which the display request for the lane image LLI is added to the speed data. The output data is output from the output data determination portion 461 to the output destination determination portion 462. The output destination determination portion 462 determines an output destination of the output data according to the contents of the output data.

The storage 432A includes a first storage 471 and a second storage 472. The first storage 471 stores image data about the boundary image BDI (c.f. FIG. 9). The second storage 472 stores image data about the lane image LLI. The first and second storages 471, 472 may be a storage domain in a common memory element. Alternatively, each of the first and second storages 471, 472 may be an individual memory element. The principles of the present embodiment are not limited to a specific structure of the first and second storages 471, 472.

The image signal generator 433A includes a first image signal processor 441A and a second image signal processor 442A. When the output data includes the display request for the lane image LLI, the output data determination portion 461 determines the first image signal processor 441A as the output destination of the output data. Otherwise, the output data determination portion 461 determines the second image signal processor 442 as the output destination of the output data.

When the output data is output from the output data determination portion 461 to the first image signal processor 441A, the first image signal processor 441A generates an image signal for use in displaying the image described with reference to FIG. 9 in response to the output data. When the output data is output from the output data determination portion 461 to the second image signal processor 442A, the second image signal processor 442A generates an image signal for use in displaying another image (e.g. the image described with reference to FIGS. 3A to 3D) in response to the output data. The optical processor 300 receives the image signal from one of the first and second image signal processors 441A, 442A.

The first image signal processor 441A includes a lower image generator 455A and a combining portion 456A. The lower image generator 455A receives the output data from the output destination determination portion 462. The lower image generator 455A processes signals according to the output data to generate lower image data representing an image to be displayed in an area below the boundary image BDI. When the output data includes the display request for the setting state image ACI, the lower image data includes information for use in displaying the running speed image RSI and the setting state image ACI. Otherwise, the lower image data includes information for use in displaying only the running speed image RSI. The lower image data is output from the lower image generator 455A to the combining portion 456A.

The combining portion 456A includes a boundary combining portion 481 and a blink processor 482. The boundary combining portion 481 receives the lower image data from the lower image generator 455A. The boundary combining portion 481 reads image data representing the boundary image BDI from the first storage 471. The boundary combining portion 481 combines the image data representing the boundary image BDI with the lower image data. The combined image data is output from the boundary combining portion 481 to the blink processor 482. The blink processor 482 reads the image data representing the lane image LLI from the second storage 472. The blink processor 482 incorporates the image data representing the lane image LLI into the image data which is received from the boundary combining portion 481. In this case, the blink processor 482 processes signals for blinking one of the left and right lane images LFI, RFI (c.f. FIG. 9). The image data generated by the blink processor 482 is output to the modulator 320 in the optical processor 300.

When the output data is output from the output destination determination portion 462 to the second image signal processor 442A, the second image signal processor 442A refers to the speed data contained in the output data to generate image data for use in displaying the running speed image RSI. When the output data includes the display request for the setting state image ACI in addition to the speed data, the second image signal processor 442A generates image data for use in displaying the running speed image RSI and the setting state image ACI. The image data generated by the second image signal processor 442A is output to the modulator 320 in the optical processor 300.

### Tenth Embodiment

The head-up display device described in the context of the ninth embodiment uses the camera device to determine whether or not a positional relationship between a vehicle and a lane is appropriate with use of a camera device. The head-up display device may use various determination techniques for determining a position of a vehicle with respect to a lane. Exemplary determination techniques are described in the tenth embodiment.

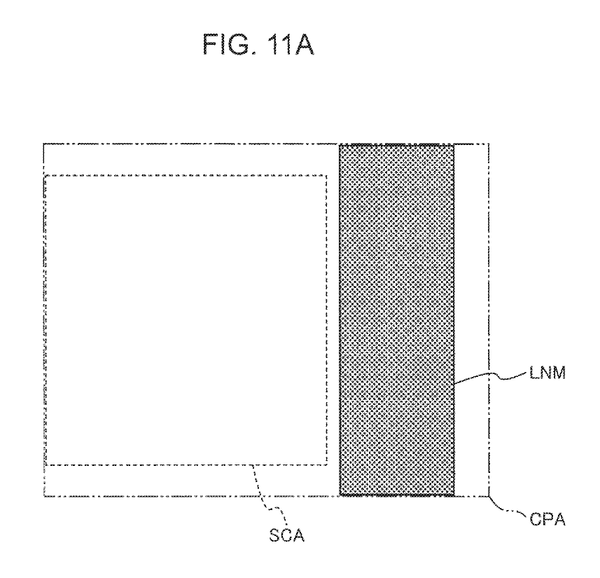

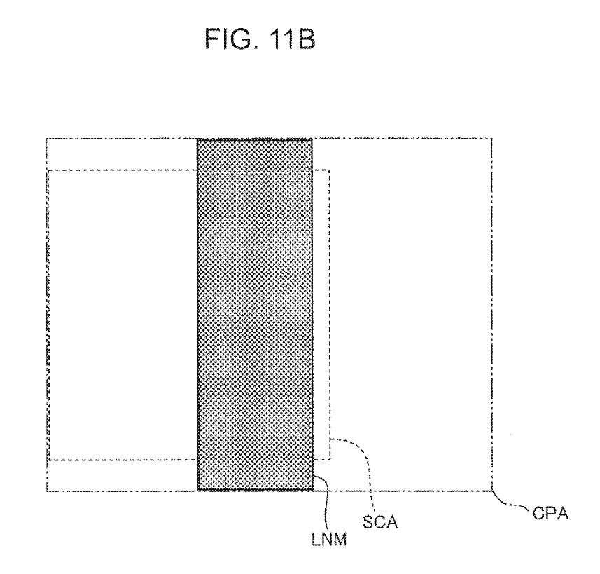

Each of FIGS. 11A and 11B are a conceptual view showing a method for determining a positional relationship between the vehicle VCL (c.f. FIG. 2) and a lane. Reference numerals used in common to the ninth and tenth embodiments indicate that elements indicated with the common reference numerals have the same functions as those of the elements in the ninth embodiment. Therefore, the description of the ninth embodiment is applied to these elements. An exemplary method for determining a positional relationship between the vehicle VCL and a lane is described with reference to FIGS. 2, 9 to 11B.

Each of FIGS. 11A and 11B shows an imaging area CPA of the camera device CMD (c.f. FIG. 10). The camera device CMD is mounted on the vehicle VCL so that a line mark LNM formed on a road surface is included in a field of view of the camera device CMD. The line mark LNM shown in each of FIGS. 11A and 11B indicates a right edge of a lane along which the vehicle VCL runs.

The image data determination portion 411 sets a scanning area SCA in the imaging area CPA. The image data determination portion 411 scans the scanning area SCA to determine whether or not the line mark LNM exists in the scanning area SCA. As shown in FIG. 11A, when the line mark LNM is out of the scanning area SCA, the image data determination portion 411 does not generate the request signal (c.f. FIG. 9). As shown in FIG. 11B, when the line mark LNM is detected in the scanning area SCA, the image data determination portion 411 generates the request signal.

The scanning area SCA may be set so that the request signal is generated before the vehicle VCL deviates from the lane. If the scanning area SCA is appropriately set, the lane image LLI (c.f. FIG. 9) is displayed in response to the request signal when there is a high risk of deviation of the vehicle VCL from the lane.

### Eleventh Embodiment

The head-up display device described in the context of the ninth embodiment may blink a lane image to notify a driver that a positional relationship between a vehicle and a lane is inappropriate. Blinking the lane image may rely on various image processing techniques. Exemplary image processing techniques for blinking a lane image is described in the eleventh embodiment.

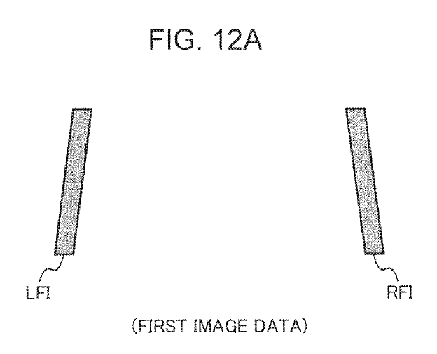

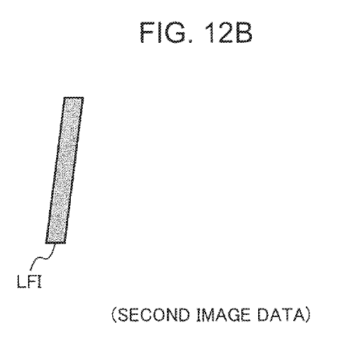

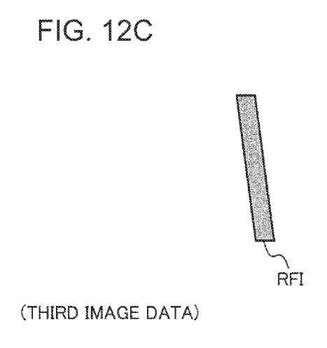

Each of FIGS. 12A to 12C is a conceptual view showing exemplary image data stored in the second storage 472 (c.f. FIG. 10). Reference numerals used in common to the ninth to eleventh embodiments indicate that elements indicated with the common reference numerals have the same functions as those of the elements in the ninth and/or tenth embodiments. Therefore, the description of the ninth and/or tenth embodiments is applied to these elements. Exemplary image processing techniques for blinking the lane image LLI (c.f. FIG. 9) is described with reference to FIGS. 2, 9 to 12C.

The determination techniques described in the context of the tenth embodiment is applied to each of a couple of line marks indicating both edges of a lane. Therefore, the image data determination portion 411 (c.f. FIG. 10) may determine whether the vehicle VCL (c.f. FIG. 2) is about to deviate to the left or the right from the lane.

When there is a high risk of deviation of the vehicle to the left, the request signal which is generated by the image data determination portion 411 may include request information which causes blinking of the left lane image LFI. When there is a high risk of deviation of the vehicle to the right, the request signal which is generated by the image data determination portion 411 may include request information which causes blinking of the right lane image RFI.

FIG. 12A shows the first image data. The first image data is usable for displaying the left and right lane images LFI, RFI.

FIG. 12B shows the second image data. The second image data is usable for displaying only the left lane image LFI.

FIG. 12C shows third image data. The third image data is usable for displaying only the right lane image RFI.

When the request signal includes request information which causes blinking of the left lane image LFI, the blink processor 482 (c.f. FIG. 10) alternately incorporates the first image data and the third image data into image data received from the boundary combining portion 481 (c.f. FIG. 10). Consequently, the left lane image LFI displayed on the windshield WSD blinks.

When the request signal includes request information which causes blinking of the right lane image RFI, the blink processor 482 alternately incorporates the first image data and the second image data into image data received from the boundary combining portion 481. Consequently, the right lane image RFI displayed on the windshield WSD blinks.

### Twelfth Embodiment

The head-up display device described in the context of the ninth embodiment may execute various processes to switch a display mode between the first and second display modes. An exemplary process for switching a display mode is described in the twelfth embodiment.

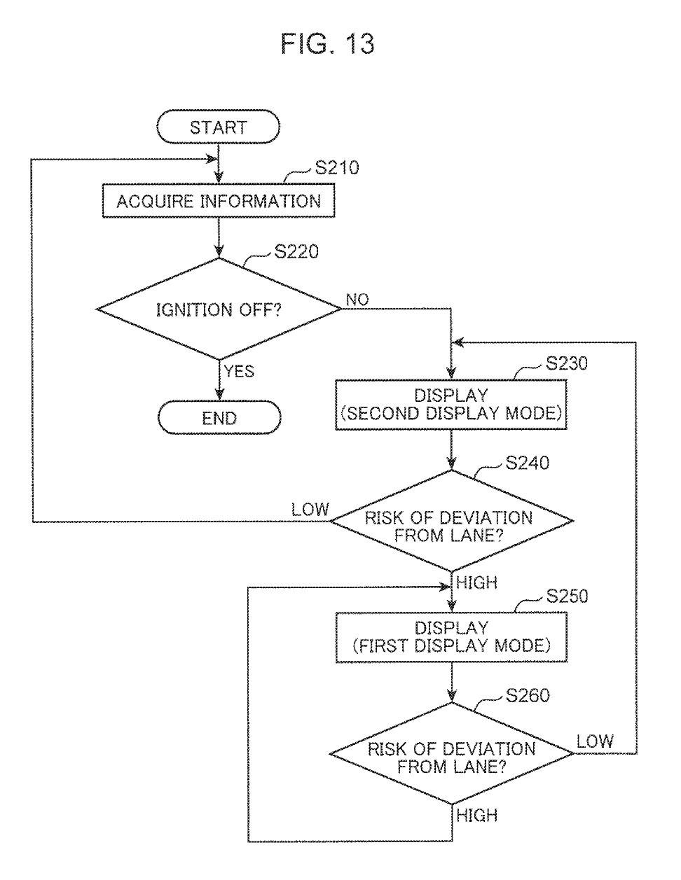

FIG. 13 is a flowchart showing an exemplary process for switching a display mode. Reference numerals used in common to the ninth to twelfth embodiments indicate that elements indicated with the common reference numerals have the same functions as those of the elements in the ninth to eleventh embodiments. Therefore, the description of the ninth to eleventh embodiments is applied to these elements. An exemplary process for switching a display mode is described with reference to FIGS. 2 to 4B, 9 to 11B and 13.

### (Step S210)

Step S210 is started, for instance, when the driver DRV (c.f. FIG. 2) turns on the ignition switch (not shown). In Step S210, the speed detector SDT (c.f. FIG. 10) in the sensor group SSH (c.f. FIG. 10) detects a running speed of the vehicle VCL (c.f. FIG. 2). The speed detector SDT generates speed data representing the detected running speed. The speed data is output from the speed detector SDT to the output data determination portion 461 (c.f. FIG. 10) via the speed data receiver 412 (c.f. FIG. 10). The camera CMD (c.f. FIG. 10) in the sensor group SSH acquires image data of the line mark LNM (FIGS. 11A and 11B) formed on a road surface. The image data is output from the camera device CMD to the image data determination portion 411. The sensor group SSH may acquire other information. For instance, the sensor group SSH may acquire information about a legal speed or a route to a destination from a navigation system (not shown) mounted on the vehicle VCL. The information from the navigation system may be used for generating the legal speed image LSI (c.f. FIG. 3D), the distance image DTI (c.f. FIG. 3D), the arrow image ARI (c.f. FIG. 3D) or the road information image RTI (c.f. FIG. 3D). After the sensor group SSH acquires information necessary for image generation, Step S220 is executed.

### (Step S220)

When the driver DRV turns off the ignition switch, the head-up display device 100 finishes the process. Otherwise, Step S230 is executed.

### (Step S230)

The output data determination portion 461 acquires the speed data but does not receive the request signal. Therefore, the output data determination portion 461 generates output data without the display request for the lane image LLI (c.f. FIG. 9). The output data is output from the output data determination portion 461 to the output destination determination portion 462 (c.f. FIG. 10). The output data does not include a display request for the lane image LLI. Therefore, the output destination determination portion 462 selects the second image signal processor 442A (c.f. FIG. 10) as the output destination of the output data. The second image signal processor 442A uses the speed data to generate image data representing various images. The image data is then output from the second image signal processor 442A to the optical processor 300 (c.f. FIG. 10). The optical processor 300 generates image light in response to the image data. The image light is then emitted onto the windshield WSD (c.f. FIG. 10) from the optical processor 300. Consequently, an image (e.g. the image described with reference to FIGS. 3A to 3D) is displayed on the windshield WSD. The windshield WSD reflects the image light. Consequently, the driver DRV may visually recognize a virtual image in correspondence to the image represented by the image light. The display operation of the head-up display device 100 in Step S230 corresponds to the second display mode described with reference to FIG. 4B. When the head-up display device 100 displays the image on the windshield WSD under the second display mode, Step S240 is executed.

### (Step S240)

The image data determination portion 411 (c.f. FIG. 10) determines a risk of deviation of the vehicle VCL from the lane according to the determination techniques described in the context of the tenth embodiment. When the image data determination portion 411 determines that there is a high risk of deviation, Step S250 is executed. Otherwise, Step S210 is executed.

### (Step S250)

The image data determination portion 411 generates a request signal requesting display of the lane image LLI. The request signal is output from the image data determination portion 411 to the output data determination portion 461. The output data determination portion 461 incorporates the display request for the lane image LLI into the output data. The output data is output from the output data determination portion 461 to the output destination determination portion 462. The output data includes the display request for the lane image LLI Therefore, the output destination determination portion 462 selects the first image signal processor 441A (c.f. FIG. 10) as the output destination of the output data. The first image signal processor 441A processes the output data according to the signal processing principles described in the context of the ninth and eleventh embodiments to generate image data representing the image described with reference to FIG. 9. The image data is then output from the first image signal processor 441A to the optical processor 300. The optical processor 300 generates an image light in response to the image signal. The image light is then emitted onto the windshield WSD from the optical processor 300. Consequently, the image (the image described with reference to FIG. 9) is displayed on the windshield WSD. The windshield WSD reflects the image light. Consequently, the driver DRV may visually recognize a virtual image in correspondence to the image represented by the image light. The display operation of the head-up display device 100 in Step S250 corresponds to the first display mode described with reference to FIG. 4A. When the head-up display device 100 displays the image on the windshield WSD under the first display mode, Step S260 is executed.

### (Step S260)

The image data determination portion 411 determines a risk of deviation of the vehicle VCL from the lane according to the determination techniques described in the context of the tenth embodiment. When the image data determination portion 411 determines that there is a high risk of deviation from the lane, Step S250 is executed. Otherwise, Step S230 is executed.

### Thirteenth Embodiment

As described in the context of the third and fourth embodiments, the head-up display device may provide a driver with navigation information for navigating to a destination under the second display mode. A head-up display device which provides a driver with navigation information under the second display mode is described in the thirteenth embodiment.

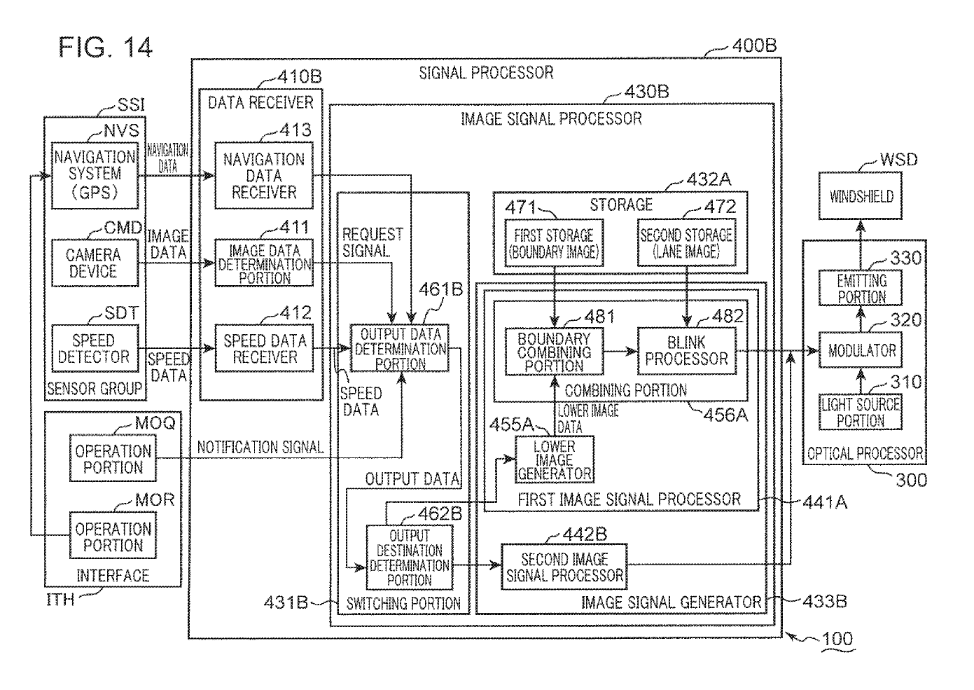

FIG. 14 is a schematic block diagram showing an exemplary functional configuration of the head-up display device 100. Reference numerals used in common to the ninth and thirteenth embodiments indicate that elements indicated with the common reference numerals have the same functions as those of the elements in the ninth embodiment. Therefore, the description of the ninth embodiment is applied to these elements. The head-up display device 100 is described with reference to FIGS. 2 to 3D, 9 and 14.

Like the ninth embodiment, the head-up display device 100 includes the optical processor 300. The description of the ninth embodiment is applied to the optical processor 300.

The head-up display device 100 further includes a signal processor 400B. The signal processor 400B may be a part of the projection device 200. Alternatively, the signal processor 400B may be a circuit provided independently of the projection device 200. In this case, the signal processor 400B may be a part of a circuit for processing various signals in the vehicle VCL (c.f. FIG. 2). The principles of the present embodiment are not limited to a specific structure of the signal processor 400B.

As described in the context of the second embodiment, the vehicle VCL includes the windshield WSD. The optical processor 300 emits the image light (the first and/or second image lights, c.f. FIG. 2) toward the windshield WSD.

The vehicle VCL includes a sensor group SSI and an interface ITH, in addition to the windshield WSD. The sensor group SSI may include various sensor elements for detecting a running state of the vehicle VCL, and various devices (e.g. a communication device) for acquiring information outside the vehicle VCL. The interface ITH receives a manual operation of the driver DRV (c.f. FIG. 2).

Like the ninth embodiment, the sensor group SSI includes the speed detector SDT and the camera device CMD. The description of the ninth embodiment is applied to the speed detector SDT and the camera device CMD,

The sensor group SSI further includes a navigation system NVS. The navigation system NVS is operated on the basis of a global positioning system (GPS) and generates navigation data. The navigation system NVS may be a commercially available device. The principles of the present embodiment are not limited to a specific device for use as the navigation system NVS.

The navigation data may include information about a position of the vehicle VCL (e.g. a name of a road on which the vehicle VCL runs or a legal speed determined for the road on which the vehicle VCL runs), or information about a positional relationship between the vehicle VCL and a destination set by the driver DRV (e.g. route information for helping arrival of the vehicle VCL at the destination, or a distance between the vehicle VCL and the destination). The principles of the present embodiment are not limited to specific contents of the navigation data.

Like the ninth embodiment, the interface ITH includes the operation portion MOQ. The description of the ninth embodiment is applied to the operation portion MOQ.

The interface ITH further includes an operation portion MOR which is operated by the driver DRV in order to activate the navigation system NVS. When the driver DRV operates the operation portion MOR to activate the navigation system NVS, the navigation system NVS generates the navigation data.

The operation portion MOR may be a touch panel (not shown) provided in the navigation system NVS. The principles of the present embodiment are not limited to a specific structure of the operation portion MOR.

The signal processor 400B includes a data receiver 410B and an image signal processor 430B.

Like the ninth embodiment, the data receiver 410B includes the image data determination portion 411 and the speed data receiver 412. The description of the ninth embodiment is applied to the image data determination portion 411 and the speed data receiver 412.

The data receiver 410B further includes a navigation data receiver 413. The navigation data receiver 413 receives the navigation data from the navigation system NVS. The navigation data is then output from the navigation data receiver 413 to the image signal processor 430B.

Like the ninth embodiment, the image signal processor 430B includes the storage 432A. The description of the ninth embodiment is applied to the storage 432A.

The image signal processor 430B further includes a switching portion 431B and an image signal generator 433B

The switching portion 431B includes an output data determination portion 461B and an output destination determination portion 462B. Like the ninth embodiment, the output data determination portion 461B receives the speed data, the request signal and the notification signal from the speed data receiver 412, the image data determination portion 411 and the operation portion MOQ. The description of the ninth embodiment is applied to the speed data, the request signal and the notification signal.

When the driver DRV operates the operation portion MOR to activate the navigation system NVS, the output data determination portion 461B may receive the navigation data from the navigation data receiver 413. The output data determination portion 461B does not receive the navigation data unless the navigation system NVS is activated.

If the output data determination portion 461B receives none of the request signal and the navigation data, the image described with reference to FIG. 3A may be displayed on the windshield WSD.

When the navigation system NVS is operated without setting a destination, the output data determination portion 461 may receive the navigation data including only information about a legal speed determined for a road on which the vehicle VCL runs. The image described with reference to FIG. 3B may be displayed on the windshield WSD unless the output data determination portion 461 receives the request signal at this time.

When the driver DRV sets a destination for the navigation system NVS, the output data determination portion 461 may receive the navigation data including information for navigating to the destination. The image described with reference to FIG. 3C or 3D may be displayed on the windshield WSD unless the output data determination portion 461 receives the request signal at this time.

When the output data determination portion 461B receives both of the request signal and the navigation data, the output data determination portion 461B incorporates the display request for the lane image LLI (c.f. FIG. 9) into the output data, and removes navigation data from the output data. When the output data determination portion 461B does not receive the request signal but receives the navigation data, the output data determination portion 461B incorporates the navigation data into the output data. The output data is output from the output data determination portion 461B to the output destination determination portion 462B.

Like the ninth embodiment, the image signal generator 433B includes the first image signal processor 441A. The description of the ninth embodiment is applied to the first image signal processor 441A.

When the output data includes the display request for the lane image LLI, the output data determination portion 461B selects the first image signal processor 441A as the output destination of the output data like the ninth embodiment. Therefore, the description of the ninth embodiment is applied to the output data determination portion 461B which selects the first image signal processor 441A as the output destination of the output data,

The image signal generator 433B further includes a second image signal processor 442B. When the navigation data incorporated in the output data includes information about a legal speed determined for a road on which the vehicle VCL runs, the second image signal processor 442B processes signals for displaying the legal speed image LSI (c.f. FIG. 3D) to generate image data. When the navigation data incorporated in the output data includes route information for navigating to a destination, the second image signal processor 442B processes signals for displaying the distance image DTI (c.f. FIG. 3)) and/or the arrow image ARI (c.f. FIG. 3D) to generate image data. When the navigation data incorporated in the output data includes information about a name of a road on which the vehicle VCL runs, the second image signal processor 442B processes signals for displaying the road information image RTI (c.f. FIG. 3D) to generate image data. The image data is output from the second image signal processor 442B to the modulator 320 in the optical processor 300.

### Fourteenth Embodiment

As described in the context of the fourth embodiment, the boundary image may be displayed only under the first display mode. Alternatively, the boundary image may be displayed not only under the first display mode but also the second display mode. When the boundary image is displayed under both of the display modes, a driver may look for information on the basis of the boundary image. As described in the context of the fifth and eighth embodiments, the first display mode is used as a display mode in which the boundary image gives visual impression like a hood of a vehicle. In this case, it is preferable that the boundary image is more highlighted under the first display mode than the second display mode. Therefore, a designer designing a head-up display device may provide a difference in display style of the boundary image between the first and second display modes. For instance, a head-up display device may use a boundary light having higher light energy to display the boundary image under the first display mode than the second display mode. Alternatively, the head-up display device may use a difference in another display style (e.g. a thickness of the boundary image, a line pattern of the boundary image (e.g. a straight line or a chain line)) to provide a difference of the boundary image between the first and second display modes. boundary images having a difference in light energy are described in the fourteenth embodiment.

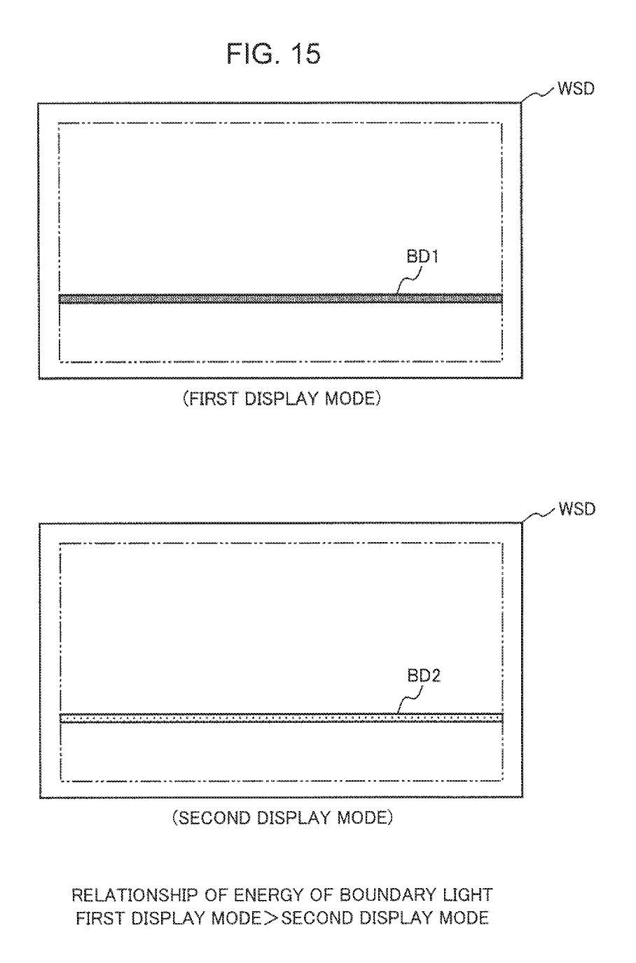

FIG. 15 is a schematic view showing boundary images BD1, BD2. The boundary images BD1, BD2 are described with reference to FIGS. 2 and 15.

The boundary image BDI is displayed on the windshield WSD under the first display mode. The boundary image BD2 is displayed on the windshield WSD under the second display mode.

The projection device 200 (c.f. FIG. 2) emits a boundary light having high energy to form the boundary image BDI under the first display mode. The projection device 200 emits a boundary light having low energy to form the boundary image BD2 under the second display mode. Therefore, the boundary image BDI can provide stronger visual impression to the driver DRV (c.f. FIG. 2) than the boundary image BD2. With regard to the present embodiment, the first boundary light is exemplified by the boundary light which is emitted from the projection device 200 under the first display mode. The second boundary image is exemplified by the boundary light which is emitted from the projection device 200 under the second display mode.

### Fifteenth Embodiment

As described in the context of the fourteenth embodiment, a difference in energy of a boundary light which forms a boundary image may be provided between the first and second display modes. The difference in energy of the boundary light may be provided by adjustment to an output of a light source which emits the boundary light. Alternatively, the difference in energy of the boundary light may be provided by modulation for a light which is emitted from a light source. A head-up display device which changes power from a light source between the first and second display modes is described in the fifteenth embodiment.

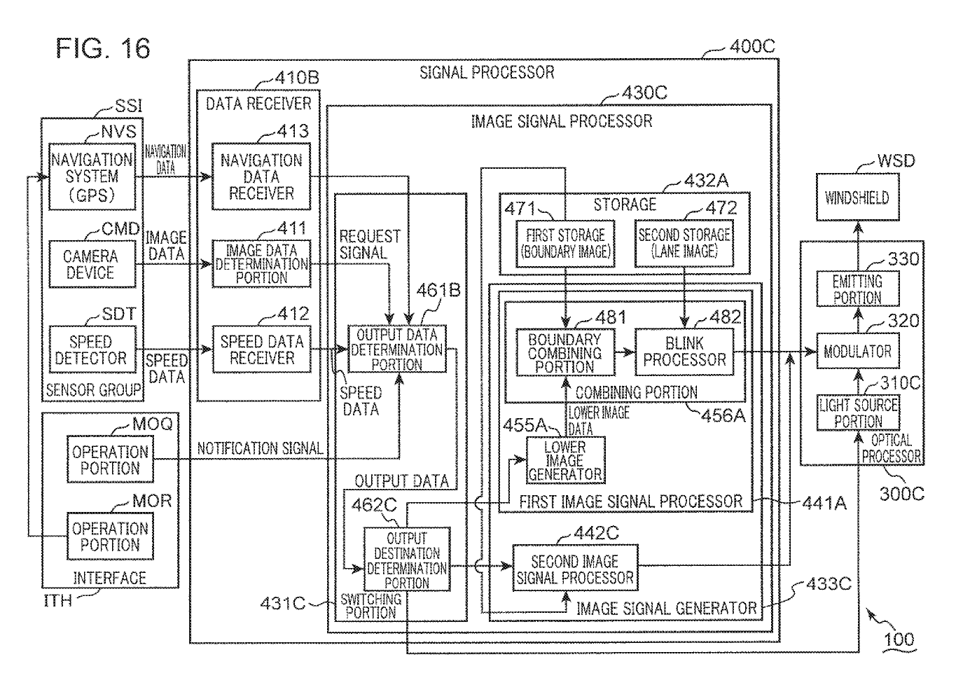

FIG. 16 is a schematic block diagram showing an exemplary functional configuration of the head-up display device 100. Reference numerals used in common to the thirteenth and fifteenth embodiments indicate that elements indicated with the common reference numerals have the same functions as those of the elements in the thirteenth embodiment. Therefore, the description of the thirteenth embodiment is applied to these elements. The head-up display device 100 is described with reference to FIGS. 2, 9, 15 and 16.

The head-up display device 100 includes an optical processor 300C and a signal processor 400C. Like the thirteenth embodiment, the optical processor 300C includes the modulator 320 and the emitting portion 330. The description of the thirteenth embodiment is applied to the modulator 320 and the emitting portion 330.

The optical processor 300C further includes a light source portion 310C. The light source portion 310C emits a boundary light having high energy under the first display mode. The light source portion 310C emits a boundary light having low energy under the second display mode.

Like the thirteenth embodiment, the signal processor 400C includes the data receiver 410B. The description of the thirteenth embodiment is applied to the data receiver 410B.

The signal processor 400C further includes an image signal processor 430C. Like the thirteenth embodiment, the image signal processor 430C includes the storage 432A. The description of the thirteenth embodiment is applied to the storage 432A.

The image signal processor 430C includes a switching portion 431C and an image signal generator 433C. Like the thirteenth embodiment, the switching portion 431C includes the output data determination portion 4611B. The description of the thirteenth embodiment is applied to the output data determination portion 461B.

The switching portion 431C further includes an output destination determination portion 462C. Like the thirteenth embodiment, the output destination determination portion 462C determines the output destination of the output data. Therefore, the description of the thirteenth embodiment is applied to the output destination determination portion 462C.

The output destination determination portion 462C not only determines the output destination of the output data but also generates a luminance signal designating luminance of the boundary light to be emitted from the light source portion 310C. When the output data from the output data determination portion 461B includes the display request for the lane image LLI (c.f. FIG. 9), the luminance signal designates high luminance. Otherwise, the luminance signal designates low luminance. The luminance signal is output from the output destination determination portion 462 to the light source portion 310C. The light source portion 310C adjusts power of the light source portion 310C in response to the luminance signal.

Like the thirteenth embodiment, the image signal generator 433C includes the first image signal processor 441A. The description of the thirteenth embodiment is applied to the first image signal processor 441A.

The image signal generator 433C further includes a second image signal processor 442C. Like the thirteenth embodiment, the second image signal processor 442C processes signals for displaying an image on the upper and lower display areas UDA, LDA (c.f. FIG. 2) in response to the output data from the output destination determination portion 462C. The description of the thirteenth embodiment is applied to signal processing of the second image signal processor 442C for displaying an image on the upper and lower display areas UDA, LDA.

The second image signal processor 442C reads image data from the first storage 471, the image data representing the boundary image BD2 (c.f. FIG. 15). The second image signal processor 442C uses the read image data to process signals for displaying the boundary image BD2.

### Sixteenth Embodiment

The head-up display device described in the context of the fifteenth embodiment may display boundary images different in luminance between the first and second display modes. Additionally or alternatively, the head-up display device may display boundary images different in thickness between the first and second display modes. A head-up display device which displays boundary images different in thickness between the first and second display modes is described in the sixteenth embodiment.

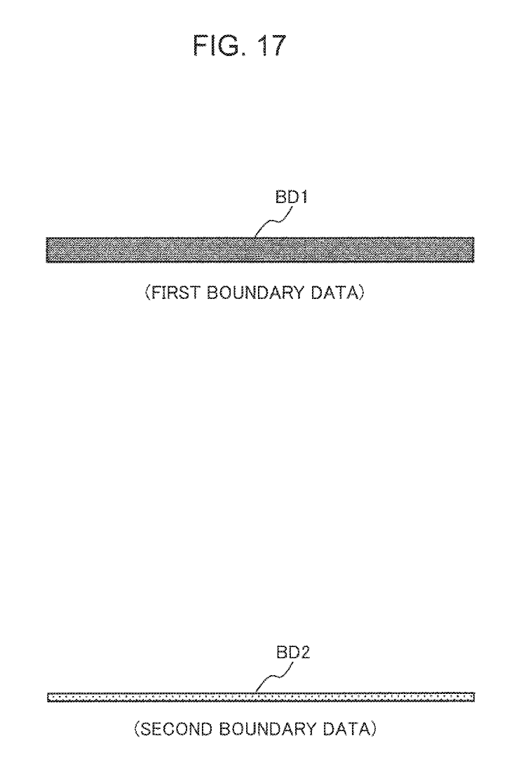

FIG. 17 is a conceptual view showing exemplary boundary data stored in the first storage 471 (c.f. FIG. 16). Reference numerals used in common to the fifteenth and sixteenth embodiments indicate that elements indicated with the common reference numerals have the same functions as those of the elements in the fifteenth embodiment. Therefore, the description of the fifteenth embodiment is applied to these elements. The head-up display device 100 (c.f. FIG. 16) is described with reference to FIGS. 16 and 17.

FIG. 17 includes first boundary data and second boundary data. The boundary image BDI formed on the basis of the first boundary data is thicker than the boundary image BD2 formed on the basis of the second boundary data.

The first storage 471 stores the first boundary data and the second boundary data. The boundary combining portion 481 (c.f. FIG. 16) in the first image signal processor 441A (c.f. FIG. 16) reads the first boundary data from the first storage 471. Consequently, the head-up display device 100 may display the wide boundary image BDI under the first display mode. The second image signal processor 442 reads the second boundary data from the first storage 471. Consequently, the head-up display device 100 may display the narrow boundary image BD2 under the second display mode.

The principles of the aforementioned various embodiments may be combined to meet requirements for vehicles.

The exemplary head-up display devices described in the context of the aforementioned various embodiments mainly include the following features.

A head-up display device according to one aspect of the aforementioned embodiments is mounted on a vehicle. The head-up display device includes a projection device which emits image light onto a reflective surface including a first area, and a second area below the first area. The image light includes first image light representing first information including information about an external factor outside the vehicle, and second image light representing second information about the vehicle itself. The projection device emits the first image light onto the first area and the second image light onto the second area.

According to the aforementioned configuration, the first image light is emitted onto the first area whereas the second image light is emitted onto the second area below the first area. Since a driver trying to acquire information about an external factor outside a vehicle directs his/her line of sight toward an upper area in many cases, the driver may intuitively acquire the first information including information about the external factor outside the vehicle. On the other hand, a driver trying to acquire information about a vehicle driven by the driver directs his/her line of sight toward a lower area in many cases. Therefore, the driver may intuitively acquire the second information about the vehicle itself.

With regard to the aforementioned configuration, the image light may include a boundary light representing a boundary between the first and second areas. The projection device may switch a display mode between a first display mode, under which the boundary light is emitted, and a second display mode under which at least one of the first and second image lights is emitted without emission of the boundary light.

According to the aforementioned configuration, since the projection device emits the boundary light under the first display mode, the first information is displayed above the boundary light whereas the second information is displayed below the boundary light. Since a positional relationship among the first information, the boundary light and the second information is similar to a positional relationship among an external factor in a field of view of a driver, a hood and an interior of the vehicle, the driver may intuitively acquire the first information and the second information. Since the projection device switches the display mode from the first display mode to the second display mode, the boundary light is not emitted unnecessarily. This results in a reduction in electric power consumption of the projection device.

With regard to the aforementioned configuration, the image light may include first boundary light representing a boundary between the first and second areas, and second boundary light representing the boundary which is different in display style from the first boundary light. The projection device may switch a display mode between a first display mode, under which the first boundary light is emitted, and a second display mode under which the second boundary light is emitted.

According to the aforementioned configuration, since the second boundary light is different in display style from the first boundary light, a driver may visually recognize a difference in display style between the first and second boundary lights and know that the display mode is switched.

With regard to the aforementioned configuration, the first boundary light may be higher in light intensity than the second boundary light.

According to the aforementioned configuration, since the first boundary light is higher in light intensity than the second boundary light, the head-up display device may emphasize the boundary between the first and second areas under the first display mode.

With regard to the aforementioned configuration, the first boundary light may draw a boundary thicker than the second boundary light.

According to the aforementioned configuration, since the first boundary light draws a boundary thicker than the second boundary light, the head-up display device may emphasize the boundary between the first and second areas under the first display mode.

With regard to the aforementioned configuration, the first information may include inter-vehicle distance information about a distance setting between the vehicle and a preceding vehicle which is targeted in an auto cruise control. The projection device may emit the first image light representing the inter-vehicle distance information under the first display mode.

According to the aforementioned configuration, since a preceding vehicle is a factor existing outside the vehicle driven by a driver, the driver is likely to direct his/her line of sight toward an upper area when the driver tries to acquire information about the preceding vehicle. Since the first image light representing inter-vehicle distance information about a distance setting between the vehicle and the preceding vehicle which is targeted in an auto cruise control is emitted onto the first area above the second area, the driver may intuitively acquire the inter-vehicle distance information.

With regard to the aforementioned configuration, the first image light may represent a symbol image indicating the preceding vehicle as the inter-vehicle distance information. When a distance between the vehicle and the preceding vehicle is set to a first value, the symbol image may be displayed so that the symbol image is distant from the boundary by a first length. When the distance between the vehicle and the preceding vehicle is set to a second value larger than the first value, the symbol image may be displayed so that the symbol image is distant from the boundary by a second length longer than the first length.

According to the aforementioned configuration, a position of the symbol image from the boundary is changed in response to a distance setting between the vehicle and the preceding vehicle. Since a positional relationship between the boundary and the symbol image is similar to a positional relationship between a hood and a preceding vehicle in a field of view of a driver, the driver may intuitively acquire the inter-vehicle distance information.

With regard to the aforementioned configuration, the first information may include lane information for use in notifying a positional relationship between the vehicle and a lane along which the vehicle runs. The projection device may emit the first image light representing the lane information under the first display mode.

According to the aforementioned configuration, since a lane is a factor existing outside the vehicle driven by a driver, the driver is likely to direct his/her line of sight toward an upper area when the driver tries to acquire information about the lane. Since the first image light representing lane information for use in notifying a positional relationship between the vehicle and the lane is emitted onto the first area above the second area, the driver may intuitively acquire the lane information.

With regard to the aforementioned configuration, the first image light may represent a straight line image as the lane information, the straight line image extending upwardly from the boundary.

According to the aforementioned configuration, since the straight line image extends upwardly from the boundary, a positional relationship between the straight line image and the boundary is similar to a positional relationship between a hood in a field of view of a driver and a line formed on a road surface. Accordingly, the driver may intuitively recognize whether or not the vehicle deviates from the lane.

With regard to the aforementioned configuration, the first information may include at least one selected from a group consisting of navigation information for navigating to a destination, legal speed information about a legal speed determined for a lane along which the vehicle runs, inter-vehicle distance information about a distance setting between the vehicle and a preceding vehicle which is targeted in an auto cruise control, and lane information for use in notifying a positional relationship between the vehicle and the lane.

According to the aforementioned configuration, since a destination, a legal speed, a preceding vehicle and a lane are factors existing outside the vehicle driven by a driver, the driver is likely to direct his/her line of sight toward an upper area when the driver tries to acquire information about these factors. Since the first image light is emitted onto the first area above the second area, the driver may intuitively acquire information about a destination, a legal speed, a preceding vehicle and a lane.

With regard to the aforementioned configuration, the second information may include at least one selected from a group consisting of running speed information about a running speed of the vehicle, and setting speed information about a running speed setting of the vehicle in the auto cruise control.

According to the aforementioned configuration, since a running speed of a vehicle is associated with a vehicle itself, the driver is likely to direct his/her line of sight toward a lower area when the driver tries to acquire running speed information or setting speed information. Since the second image light is emitted onto the second area below the first area, the driver may intuitively acquire the information about a running speed of the vehicle.

### INDUSTRIAL APPLICABILITY

The principles of the aforementioned embodiments are advantageously used in designing various vehicles.

1-11. (canceled)

12. A head-up display device which is mounted on a vehicle, comprising:
a projection device which emits an image light onto a reflective surface including a first area, and a second area below the first area,
wherein the image light includes a first image light representing first information including information about an external factor outside the vehicle, and a second image light representing second information about the vehicle itself, and
wherein the projection device emits the first image light onto the first area and the second image light onto the second area.

13. The head-up display device according to claim 12,
wherein the image light includes a boundary light representing a boundary between the first and second areas, and
wherein the projection device switches a display mode between a first display mode, under which the boundary light is emitted, and a second display mode, under which at least one of the first and second image lights is emitted without emission of the boundary light.

14. The head-up display device according to claim 12,
wherein the image light includes a first boundary light representing a boundary between the first and second areas, and a second boundary light representing the boundary which is different in display style from the first boundary light, and
wherein the projection device switches a display mode between a first display mode, under which the first boundary light is emitted, and a second display mode under which the second boundary light is emitted.

15. The head-up display device according to claim 14,
wherein the first boundary light is higher in light intensity than the second boundary light.

16. The head-up display device according to claim 14,
wherein the first boundary light draws the boundary thicker than the second boundary light.

17. The head-up display device according to claim 15,
wherein the first boundary light draws the boundary thicker than the second boundary light.

18. The head-up display device according to claim 13,
wherein the first information includes inter-vehicle distance information about a distance setting between the vehicle and a preceding vehicle which is targeted in an auto cruise control, and
wherein the projection device emits the first image light representing the inter-vehicle distance information under the first display mode.

19. The head-up display device according to claim 18,
wherein the first image light represents a symbol image indicating the preceding vehicle as the inter-vehicle distance information,
wherein the symbol image is displayed so that the symbol image is distant from the boundary by a first length when a distance between the vehicle and the preceding vehicle is set to a first value, and
wherein the symbol image is displayed so that the symbol image is distant from the boundary by a second length longer than the first length when the distance between the vehicle and the preceding vehicle is set to a second value larger than the first value.

20. The head-up display device according to claim 13,
wherein the first information includes lane information for use in notifying a positional relationship between the vehicle and a lane along which the vehicle runs, and wherein the projection device emits the first image light representing the lane information under the first display mode.

21. The head-up display device according to claim 20,
wherein the first image light represents a straight line image as the lane information, the straight line image extending upwardly from the boundary.

22. The head-up display device according to claim 12,
wherein the first information includes at least one selected from a group consisting of navigation information for navigating to a destination, legal speed information about a legal speed determined for a lane along which the vehicle runs, inter-vehicle distance information about a distance setting between the vehicle and a preceding vehicle which is targeted in an auto cruise control, and lane information for use in notifying a positional relationship between the vehicle and the lane.

23. The head-up display device according to claim 22,
wherein the second information includes at least one selected from a group consisting of running speed information about a running speed of the vehicle, and setting speed information about a running speed setting of the vehicle in the auto cruise control.

24. A head-up display device which is mounted on a vehicle, comprising:
a projection device which emits an image light onto a reflective surface including a first area, and a second area below the first area,
wherein the image light includes a first image light representing first information including information about an external factor outside the vehicle, and a second image light representing second information about the vehicle itself,
wherein the projection device emits the first image light onto the first area and the second image light onto the second area,
wherein the image light includes a first boundary light representing a boundary between the first and second areas, and a second boundary light representing the boundary which is different in display style from the first boundary light,
wherein the projection device switches a display mode between a first display mode, under which the first boundary light is emitted, and a second display mode under which the second boundary light is emitted,
wherein the first information includes inter-vehicle distance information about a distance setting between the vehicle and a preceding vehicle which is targeted in an auto cruise control, and
wherein the projection device emits the first image light representing the inter-vehicle distance information under the first display mode.

25. The head-up display device according to claim 24,
wherein the first image light represents a symbol image indicating the preceding vehicle as the inter-vehicle distance information,
wherein the symbol image is displayed so that the symbol image is distant from the boundary by a first length when a distance between the vehicle and the preceding vehicle is set to a first value, and
wherein the symbol image is displayed so that the symbol image is distant from the boundary by a second length longer than the first length when the distance between the vehicle and the preceding vehicle is set to a second value larger than the first value.

26. A head-up display device which is mounted on a vehicle, comprising:
a projection device which emits an image light onto a reflective surface including a first area, and a second area below the first area,
wherein the image light includes a first image light representing first information including information about an external factor outside the vehicle, and a second image light representing second information about the vehicle itself,
wherein the projection device emits the first image light onto the first area and the second image light onto the second area,
wherein the image light includes a first boundary light representing a boundary between the first and second areas, and a second boundary light representing the boundary which is different in display style from the first boundary light,
wherein the projection device switches a display mode between a first display mode, under which the first boundary light is emitted, and a second display mode under which the second boundary light is emitted,
wherein the first information includes lane information for use in notifying a positional relationship between the vehicle and a lane along which the vehicle runs, and
wherein the projection device emits the first image light representing the lane information under the first display mode.

27. The head-up display device according to claim 26,
wherein the first image light represents a straight line image as the lane information, the straight line image extending upwardly from the boundary.
